(19) United States
(12) Patent Application Publication
(10) Pub. No.: US 2015/0169301 A1
(43) Pub. Date: Jun. 18, 2015

(54) PROGRAM SPECIFICATION ESTIMATION DEVICE, METHOD OF THE SAME, AND NON-TRANSITORY COMPUTER READABLE MEDIUM

(71) Applicant: Kabushiki Kaisha Toshiba, Minato-ku (JP)

(72) Inventor: Takeo IMAI, Setagaya (JP)

(73) Assignee: Kabushiki Kaisha Toshiba, Minato-ku (JP)

(21) Appl. No.: 14/565,514

(22) Filed: Dec. 10, 2014

(30) Foreign Application Priority Data
Dec. 12, 2013 (JP) 2013-257239

(51) Int. Cl. G06F 9/45; G06F 9/44

(52) U.S. Cl. CPC G06F 8/41; G06F 8/70

(57) ABSTRACT

In a program specification estimation device, first circuitry generates a plurality of negative covering sets; second circuitry lists first unsatisfiable cores on a basis of all the predicates included in the plurality of negative covering sets; third circuitry obtains a program logical formula by converting the program to a form of a logical formula by symbolic execution; and fourth circuitry obtains a solution that makes the logical formula including a conjunction of (1) a disjunction of each of relaxing variable and the predicate corresponding to each of the relaxing variable, (2) the program logical formula and (3) an additional constraint be true, and converts a correction subset that is a set of the predicates for which the relaxing variables have become true to a second unsatisfiable core.

### CROSS-REFERENCE TO RELATED APPLICATIONS

This application is based upon and claims the benefit of priority from Japanese Patent Application No. 2013-257239, filed Dec. 12, 2013; the entire contents of which are incorporated herein by reference.

### FIELD

An embodiment of the present invention relates to a program specification estimation device, its method, and a non-transitory computer readable medium.

### BACKGROUND

A technology of estimating preconditions of a program as specifications of the program is known. A precondition is a prerequisite condition for a normal operation of the program. When the program is executed in the state that the precondition is established, a predetermined postcondition is established. The postcondition is a condition guaranteed when the program is normally operated.

As a method of estimating the preconditions, a method of generating a logical formula using a predicate generated from text of a program, the postcondition given beforehand, and a program logical formula for which the program is converted to a logical formula, and listing unsatisfiable cores which are sets of conflicting predicates is known. The predicate is a logical formula determined to be true or false according to a parameter (if there is any), and is also called a constraint. The unsatisfiable core is, for a set of the logical formulas, when conjunction (logical product) of all the elements are unsatisfiable, a subset thereof in which the conjunction are also unsatisfiable.

In this method, a calculation amount is extremely large and there have been difficulties in a processing speed and scalability.

Also, there is a method of acquiring a correction subset as an intermediate solution before acquiring the unsatisfiable core, and converting the intermediate solution to the unsatisfiable core. The correction subset is, for a set of the logical formulas, when conjunction of all the elements are unsatisfiable, a subset thereof whose removal from the original set causes the conjunction to be satisfiable. In this method, while it is needed to tentatively list all the correction subsets, the number of the correction subsets to be listed becomes large and processing is not always efficient.

### BRIEF DESCRIPTION OF THE DRAWINGS

FIG. 1 is a diagram illustrating an entire configuration of a program specification estimation system including a program specification estimation device according to an embodiment of the present invention;

FIG. 2 is a diagram illustrating a processing flow of the system in FIG. 1;

FIG. 3 is a diagram illustrating a configuration of a predicate generator;

FIG. 4 is a diagram illustrating a configuration of an inter-predicate unsatisfiable core lister;

FIG. 5 is a diagram illustrating a processing flow of the inter-predicate unsatisfiable core lister;

FIG. 6 is a diagram illustrating a configuration of a partial unsatisfiable core lister;

FIG. 7 is a diagram illustrating a processing flow of the inter-predicate unsatisfiable core lister;

FIG. 8 is a diagram illustrating a configuration of a whole unsatisfiable core lister;

FIG. 9 is a diagram illustrating a configuration of an unsatisfiable core lister;

FIG. 10 is a diagram illustrating a processing flow of the unsatisfiable core lister;

FIG. 11 is a diagram illustrating an example of program text;

FIG. 12 is a diagram illustrating an example of an additional constraint (a negation of a postcondition);

FIG. 13 is a diagram illustrating an example of an attribute pattern;

FIG. 14 is a diagram illustrating an example of a predicate pattern;

FIG. 15 is a diagram illustrating an example of stored contents of a predicate storage and a negative covering storage;

FIG. 16 is a diagram illustrating an example of stored contents of an intermediate result storage;

FIG. 17 is a diagram illustrating an example of stored contents of the intermediate result storage;

FIG. 18 is a diagram illustrating an example of stored contents of a division information storage, a partial predicate storage, and a partial unsatisfiable core storage;

FIG. 19 is a diagram illustrating an example of stored contents of the intermediate result storage;

FIG. 20 is a diagram illustrating an example of stored contents of an allocation information storage, the partial predicate storage, and the partial unsatisfiable core storage;

FIG. 21 is a diagram illustrating an example of stored contents of the intermediate result storage;

FIG. 22 is a diagram illustrating an example of stored contents of a predicate storage, an invariable constraint storage, a number storage, and an unsatisfiable core storage;

FIG. 23 is a diagram illustrating another configuration example of the inter-predicate unsatisfiable core lister; and

FIG. 24 is a hardware block diagram of the system in FIG. 1.

### DETAILED DESCRIPTION

According to one embodiment, there is provided a program specification estimation device, including first circuitry (a predicate generator), second circuitry (a first unsatisfiable core lister), third circuitry (a program converter) and fourth circuitry (a second unsatisfiable core lister).

The first circuitry analyzes a program described by an imperative programming language and detects a parameter included therein, and generates a plurality of negative covering sets each of which includes a plurality of predicates each including the parameter wherein a conjunction of arbitrary zero or more predicates in each negative covering set is a negation of a conjunction of the other predicates therein.

The second circuitry lists first unsatisfiable cores that are minimal sets of the predicates that respective conjunctions thereof conflict, on a basis of all the predicates included in the plurality of negative covering sets.

The third circuitry converts the program to a form of a logical formula with use of symbolic execution to obtain a program logical formula.

The fourth circuitry sets a relaxing variable which takes a true or false value to each of all the predicates included in the plurality of negative covering sets.

The fourth circuitry obtains a solution that makes a logical formula be true so as to satisfy a first constraint and a second constraint, the logical formula including a conjunction of (1) a disjunction of each of the relaxing variable and the predicate corresponding to each of the relaxing variable, (2) the program logical formula and (3) an additional constraint given beforehand, the first constraint being a constraint related to a number of relaxing variables to be true, that is determined according to a number of the negative covering sets generated by the first circuitry, and the second constraint being a constraint that at least one of the predicates included in each of the first unsatisfiable cores becomes true and the rest of the predicates become false.

The fourth circuitry converts a correction subset that is a set of the predicates for which the relaxing variables have become true to a second unsatisfiable core, the second unsatisfiable core being a minimal set of the predicates which cannot be made true simultaneously with the additional constraint in a case of finding a solution that makes a logical formula including a conjunction of (1) the second unsatisfiable core, (2) the program logical formula and (3) the additional constraint be true.

Below, logic symbols to be used in this specification are indicated.
[symbol] : Conjunction (logical product or AND)
[symbol] : Disjunction (logical sum or OR)
[symbol] : Negation (NOT)
[symbol] : Implication (“if-then”)
⊥: Contradiction
∀: Universal quantification (“arbitrary” or “all”)
Further, symbols of a set theory to be used in this specification are indicated below.
ε: Contained as element
⊂: Subset
¥: Difference set

Also, definitions of terms to be used in this specification are indicated.

[Size] A size is the number of elements included in a set.

[Conjunction] A conjunction is a logical product, that is, AND.

[Disjunction] A disjunction is a logical sum, that is, OR.

[Unsatisfiable core, or unsatisfiable subset]

For a set of logical formulas, when the conjunction (logical product) of all the elements are unsatisfiable (the set is inconsistent), an unsatisfiable core is a subset thereof in which the conjunction is also unsatisfiable. In other words, for a set “P” of the logical formulas, when “ [symbol] P=⊥”, it is to be “P′⊂P” and “ [symbol] P′=⊥”.

[Minimal unsatisfiable core, or minimal unsatisfiable subset]

A minimal unsatisfiable core is minimal among the unsatisfiable cores. That is, it is the unsatisfiable core in which all proper subsets are satisfiable. In other words, it is the unsatisfiable core “P” for the set “P” of the logical formulas and is “∀pεP′. [symbol] (P′¥p)≠⊥”. In this specification, unless otherwise mentioned, “unsatisfiable core” indicates “minimal unsatisfiable core”.

[Correction Subset] For a set of logical formulas, when the conjunction of all the elements are unsatisfiable, a correction subset is a subset thereof whose removal from the original set causes the conjunction to be satisfiable. In other words, for the set “P” of the logical formulas, when “ [symbol] P=⊥”, it is to be “P′⊂P” and also “ [symbol] (P¥P′)≠⊥”.

[Minimal Correction Subset]

A minimal correction subset is minimal among the correction subsets. That is, removal of any proper subset from the original correction subset does not cause satisfaction. In other words, among the correction subsets “P” of the inconsistent set “P” of the logical formulas, it is to be “∀pεP′. [symbol] (P¥(P′¥p))=⊥”. In this specification, unless otherwise mentioned, “correction subset” indicates “minimal correction subset”.

[Precondition/Postcondition] It is one form of specifications of a program. A precondition is a prerequisite condition for a normal operation of the program. A postcondition is a condition guaranteed when the program is normally operated.

The precondition and the postcondition are handled in a pair. Logically, when the precondition of a certain program is defined as “P”, the postcondition is defined as “T”, and a symbol indicating that the program is operated is “S”, it is “P [symbol] S [symbol] T”.

Hereinafter, with reference to the drawings, an embodiment of the present invention will be described.

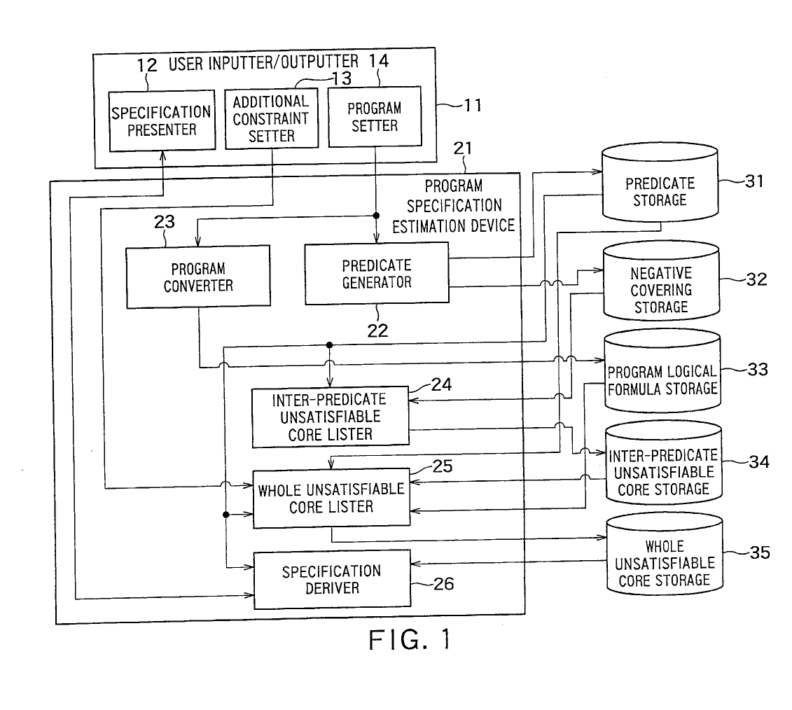

FIG. 1 is a functional block diagram of a program specification estimation system including a program specification estimation device according to the embodiment of the present invention.

In this system, a program described by an imperative programming language and an additional constraint to the program are inputted, and the precondition of the program (program specification) is obtained and outputted. The present embodiment illustrates a case that the additional constraint is a negation of the postcondition of the program, however, it is not limited thereto. The present system includes, an inputter/outputter 11 to a user, a program specification estimation device 21, and various kinds of storages 31-35. While the storages 31-35 are arranged on an outer side of the program specification estimation device 21 in the figure, a configuration that they are provided inside the program specification estimation device 21 is also possible.

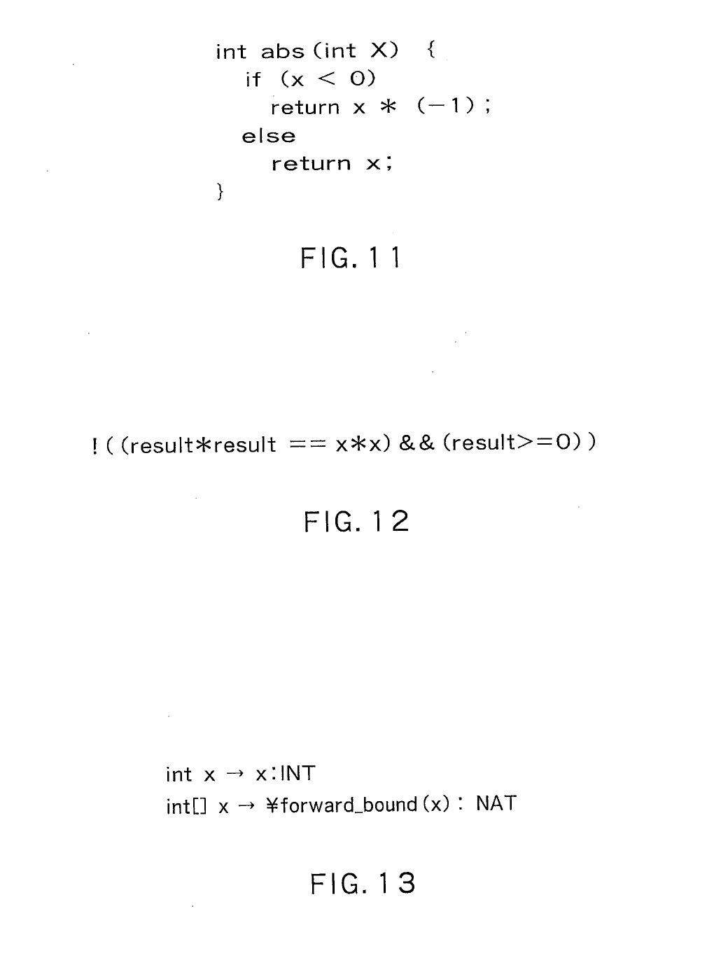

A program setter 14 receives text of a program to be a target of specification estimation from a user. Here, as an example, it is assumed that, to the program setter 14, program text of a C language function that calculates an absolute value as illustrated in FIG. 11 is set from the user. The program has “x” which is an int (integer) type as an input parameter. When “x” is 0 or larger, “x” is outputted, and when “x” is smaller than 0, “x” is multiplied with −1 and outputted.

An additional constraint setter 13 receives the additional constraint to be used for the specification estimation as input.

In the present embodiment, the negation of the postcondition is received as the additional constraint. Here, as the additional constraint, it is assumed that the negation of the postcondition as illustrated in FIG. 12 is set from the user. It indicates the negation of “a return value of a function is the absolute value of “x”” using grammar of C language. “The return value of the function is the absolute value of “x”” is the postcondition. “result” is a special symbol indicating the return value of the function. It is assumed that “result” is uniformly interpreted as this meaning through the present device. In this specification, the additional constraint is described as “Q”.

A predicate generator 22, which corresponds to first circuitry or a first unsatisfiable core lister, of the program specification estimation device 21 acquires the program text from the program setter 14, and generates a predicate group on the basis of a parameter included in the program text and its type. The predicate is a logical formula determined to be true or false according to the parameter (if there is any), and is also called a constraint. The specification (precondition) to be output of the present embodiment is obtained as one or a plurality of sets of these predicates.

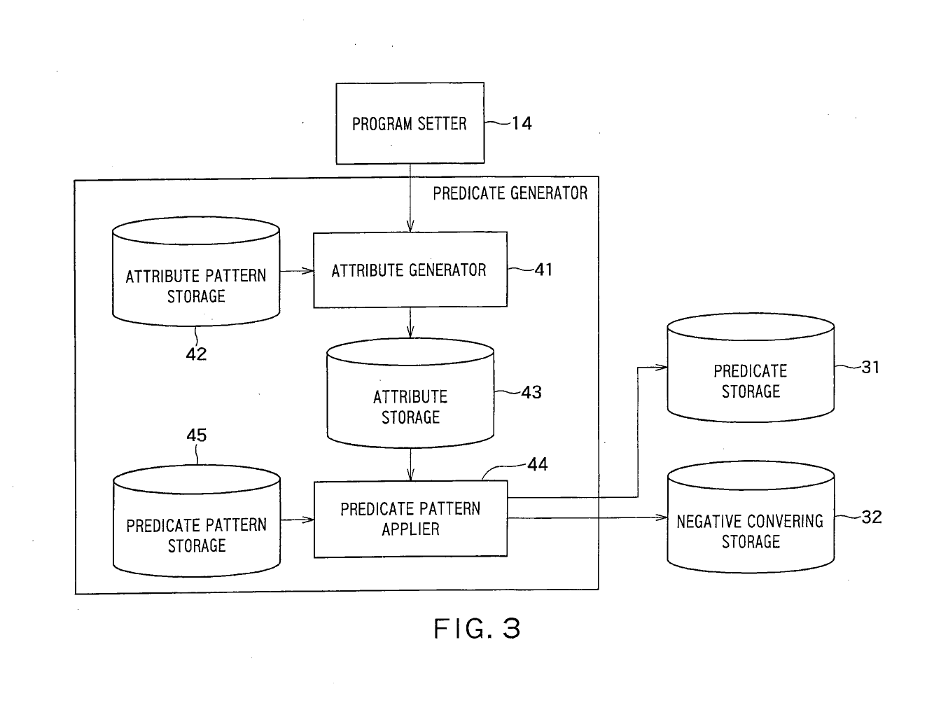

FIG. 3 illustrates a configuration of the predicate generator 22.

An attribute pattern storage 42 stores an attribute pattern. The attribute pattern determines a conversion rule to an attribute to be used in generation of the predicate to be described later, according to the parameter and its type.

FIG. 13 illustrates an example of the attribute pattern stored in the attribute pattern storage 42.

Two attribute patterns are illustrated. Each attribute pattern is described as a rule of one row each. The first row “int x→x: INT” is interpreted as that the int type parameter “x” is converted to “x” (practically, nothing is converted). Here, “INT” of a right side “x: INT” is interpreted as that the attribute after conversion has an INT (integer) type.

A left side “int[ ]” of the second row “int[ ] x→¥forward_bound(x): NAT” means an array type of “int”. From this, the attribute pattern of the second row is interpreted as that the parameter “x” having the array type of “int” is converted to the text of the attribute that is “¥forward_bound(x)”. Also, it is defined that “¥forward_bound(x)” indicates “a size of a memory area indicated by “x””. This “¥forward_bound(x)” appears in Non Patent Literature 1 and is realizable by a known technology. Then, from “NAT” on the right side, it is interpreted that “¥forward_bound(x)” has a NAT type (non negative integer type).

An attribute generator 41 reads the attribute patterns from the attribute pattern storage 42, and reads the program text from the program setter 14. The attribute generator 41 reads the parameter described in the program text and its type, matches the read parameter and its type and the left side of the attribute pattern, and specifies a matching attribute pattern. Then, by the specified attribute pattern, the parameter is converted to the attribute. In this example, since there is an integer type parameter “x” in the program text, “x: INT” is obtained as the attribute. The attribute generator 41 stores the text “x: INT” of the acquired attribute in an attribute storage 43. In this example, the parameter that matches with the attribute pattern on a lower side in FIG. 13 is not included in the program text.

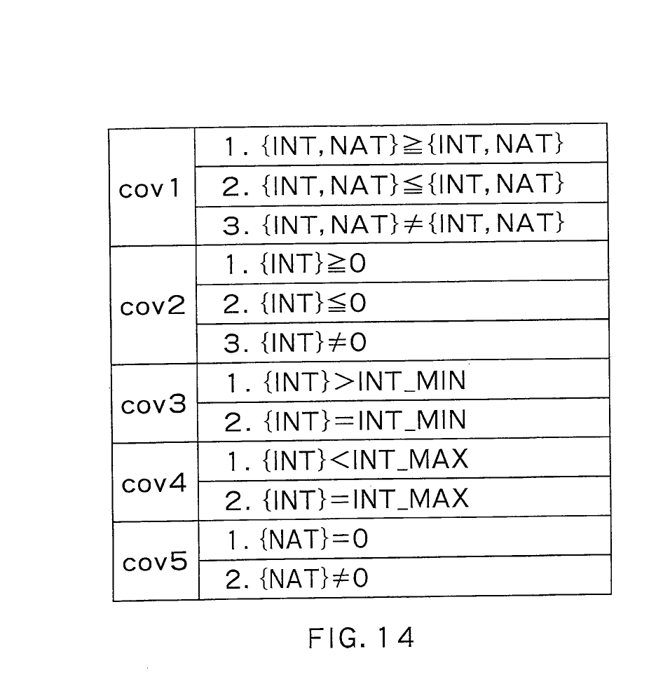

A predicate pattern storage 45 stores 12 predicate patterns as illustrated in FIG. 14. The predicate pattern indicates a generation rule of the predicate based on the parameter. The 12 predicate patterns are grouped, and there exist five sets of cov1-cov5. Here, “INT_MIN” and “INT_MAX” are special symbols indicating the minimum value and the maximum value of the int type, respectively. It is assumed that “INT_MIN” and “INT_MAX” are uniformly interpreted as this meaning through the present device. “INT_MIN” and “INT_MAX” may be specific numerical values respectively or may be character labels of “INT_MIN” and “INT_MAX”.

Here, cov1-cov5 indicate a predicate pattern group configuring relationship of negative covering respectively, and are also called negative covering pattern sets. The predicate group generated from the predicate pattern group belonging to the same negative covering pattern set is called the negative covering set.

Here, the negative covering indicates the relationship that, in the case that the set is divided into arbitrary two, the conjunction (logical product) of all the predicates belonging to one is the negation of the conjunction of all the predicates belonging to the other. The set of the predicates satisfying such relationship is called the negative covering set. Therefore, the negative covering set is also the unsatisfiable core (since, when even one element is taken out from the negative covering set, the conjunction of the remaining elements becomes true).

For instance, for two variables “A” and “B” that are integers, {A=B, A≠B} is the negative covering set. The reason is as follows. As a method of dividing the set into two, there are two kinds that are
1. { } (empty set) and {A=B, A≠B}
2. {A=B} and {A≠B}

In the case of the first division, it is a logically proper method that the conjunction of all the predicates belonging to { } is assumed to be TRUE (always true). Also, the conjunction of all the predicates belonging to {A=B, A≠B} is “A=B [symbol] A≠B” and is FALSE (always false). Therefore, the conjunction of all the predicates belonging to one of { } and {A=B, A≠B} becomes the negation of the conjunction of all the predicates belonging to the other.

Also, in the case of the second division, the conjunction of all the predicates belonging to {A=B} is A=B, and it is the negation of the conjunction A≠B of all the predicates belonging to {A≠B}. Therefore, the conjunction of all the predicates belonging to one of {A=B} and {A≠B} becomes the negation of the conjunction of all the predicates belonging to the other.

In addition, {A≧B, A≦B, A≠B} forms the negative covering set. The reason is as follows.

There are four methods of dividing it into two, that are
1. { } (empty set) and {A≧B, A≦B, A≠B}
2. {A≧B} and {A≦B, A≠B}
3. {A≦B} and {A≠B, A≧B}
4. {A≠B} and {A≧B, A≦B}

In all of the four, when the conjunction of the predicates is taken for each of left and right division sets, it is
1. TRUE and FALSE
2. A≧B and A<B
3. A≦B and A>B
4. A≠B and A=B
   and the one is the negation of the other.

In the predicate pattern storage 45, the user sets the predicate pattern group forming the negative covering like this beforehand.

The predicate pattern group forming the negative covering may be generated using a method of generating the predicate group so as to automatically guarantee the negative covering. For instance, there is a method of generating, for one predicate pattern, a predicate “H” that can be generated by using the pattern and “ [symbol] H” which is the negation of “H”. It is because that a set {H, [symbol] H} surely becomes the negative covering.

As illustrated in FIG. 14, on the right of the individual negative covering pattern sets cov1-cov5, the predicate patterns are described in each row.

“{ }” inside each predicate pattern indicates a part to apply the attribute. “INT” or “NAT” described in “{ }” indicates the applicable attribute. For instance, “{INT}” can be replaced with the attribute of the INT type, and “{INT, NAT}” can be replaced with the attribute of the INT type or the NAT type. The individual predicate patterns included in the same negative covering pattern set specify the same attributes. Therefore, the negative covering pattern set is associated with the same attribute as the individual predicate patterns therein.

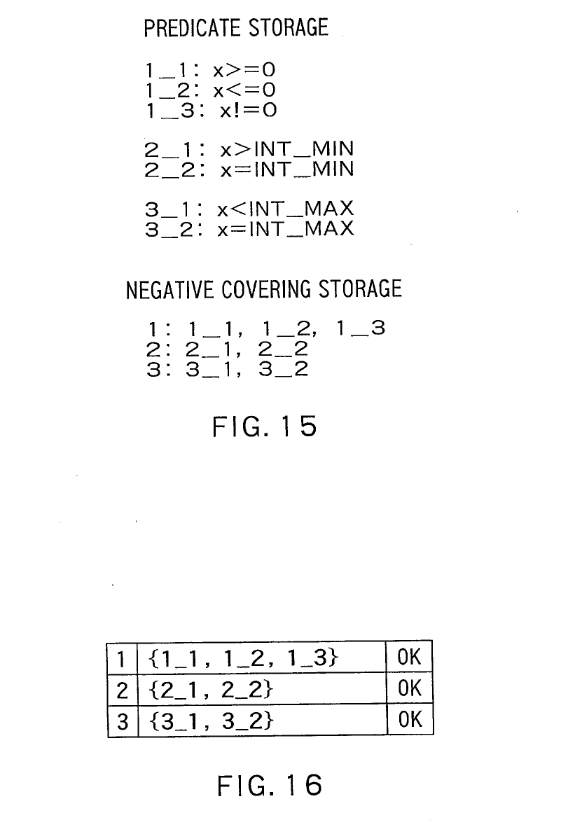

In this example, from the attribute “x: INT” stored in the attribute storage 43 and the negative covering pattern sets cov2-cov4 in FIG. 14 stored in the predicate pattern storage 45, seven predicates at the upper part of FIG. 15 are generated. A predicate pattern applier 44 stores the generated predicates in a predicate storage 31. Since the predicate pattern of cov5 does not include the INT type, “x: INT” cannot be applied. The predicate pattern of cov1 is not utilized here because of a reason to be described later (however, even if it is utilized, there is no problem in terms of operations in the present invention). In this way, the predicate generator 22 specifies the negative covering pattern set according to the parameter detected from the program and its type among the plurality of negative covering pattern sets, and generates the predicate using the specified negative covering pattern set.

When storing the generated predicates in the predicate storage 31, the predicate pattern applier 44 allocates indexes (serial No.s) to be unique as a whole to the individual predicates. Specifically, “1_{—}1”, “1_{—}2” and “1_{—}3” are generated from cov2 and the attribute “x: INT”, “2_{—}1” and “2_{—}2” are generated from cov3 and the same attribute, “3_{—}1” and “3_{—}2” are generated from cov4 and the same attribute, and these indexes are imparted to the individual predicates. In the predicate storage 31, the predicates to which the indexes are imparted are stored.

Here, the reason for not utilizing the predicate pattern belonging to cov1 will be described. The predicate formed by applying the same attribute to the predicate pattern of cov1 in FIG. 14 (“n≠n”, for instance) is only the logically obvious one. Therefore, even when such a predicate is generated, subsequent processing just becomes redundant. Therefore, in this example, the predicate is not generated from the predicate pattern belonging to cov1. However, even if such a predicate is generated, the operation is possible without any problem.

The predicate pattern applier 44 stores a set configuration of the predicates generated from the same negative covering relationship in a negative covering storage 32 as in the lower part of FIG. 15. In the case of the above-described example, the three negative covering sets of {1_{—}1, 1_{—}2, 1_{—}3}, {2_{—}1, 2_{—}2} and {3_{—}1, 3_{—}2} are stored in the negative covering storage 32. At the time, numbers 1, 2, and 3 are imparted respectively to the individual sets. Also, the elements of the individual sets are described using the index imparted to the predicate. A method of directly described predicate without using the index is also possible.

A program converter 23 in FIG. 1 converts the program text inputted from the program setter 14 to the logical formula.

The program converter 23 in FIG. 1 converts the program to the logical formula by using the known technology called symbolic execution. The symbolic execution is described in Non Patent Literature (King, Symbolic execution and program testing, Communications of the ACM, Volume 19 Issue 7, July 1976, Pages 385-394). A method of converting a C language program to the logical formula by the symbolic execution is described in Non Patent Literature (Sakai, Maruchi, and Imai, Model-Checking C Programs against JML-like Specification Language. Proceedings of 19th Asia-Pacific Software Engineering Conference (APSEC 2012), Pages 174-183), and it is assumed that the method in the Literature is used in the present embodiment.

The program converter 23 stores a result (program logical formula) for which the program text is converted to the logical formula in a program logical formula storage 33.

When the program illustrated in FIG. 11 is converted to the logical formula by the symbolic execution, the logical formula (program logical formula) equivalent to the following is obtained as a result. The program logical formula will be described by “Ps” hereinafter.
(x<0 [symbol] result=x*(−1)) [symbol] [symbol] (x<0) [symbol] result=x)

An inter-predicate unsatisfiable core lister 24 in FIG. 1, which corresponds to second circuitry, lists the minimal sets of the predicates for which respective conjunction conflict as inter-predicate unsatisfiable cores, on the basis of all the predicates inside the predicate storage 31 (being minimal means that removal of any element from the set causes the conjunction of the elements that remain after the removal to be true). In this example, the correction subset (inter-predicate correction subset) which is the set of the predicates whose removal from all the predicates causes the conjunction of the predicates that remain after the removal to be true is obtained first. The obtained correction subset is converted to the inter-predicate unsatisfiable core by the known technology. However, though there is the possibility that a calculation amount becomes large, the inter-predicate unsatisfiable core may be obtained directly from all the predicates without obtaining the correction subset. It is possible by using a known SAT (satisfiability) solver or SMT (SAT Modulo Theories) solver or the like.

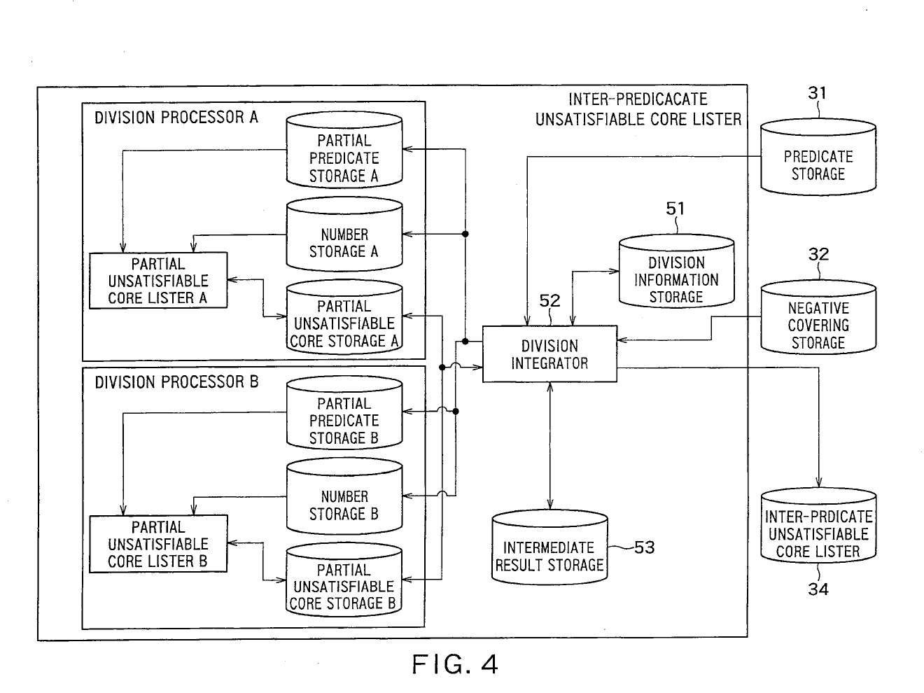

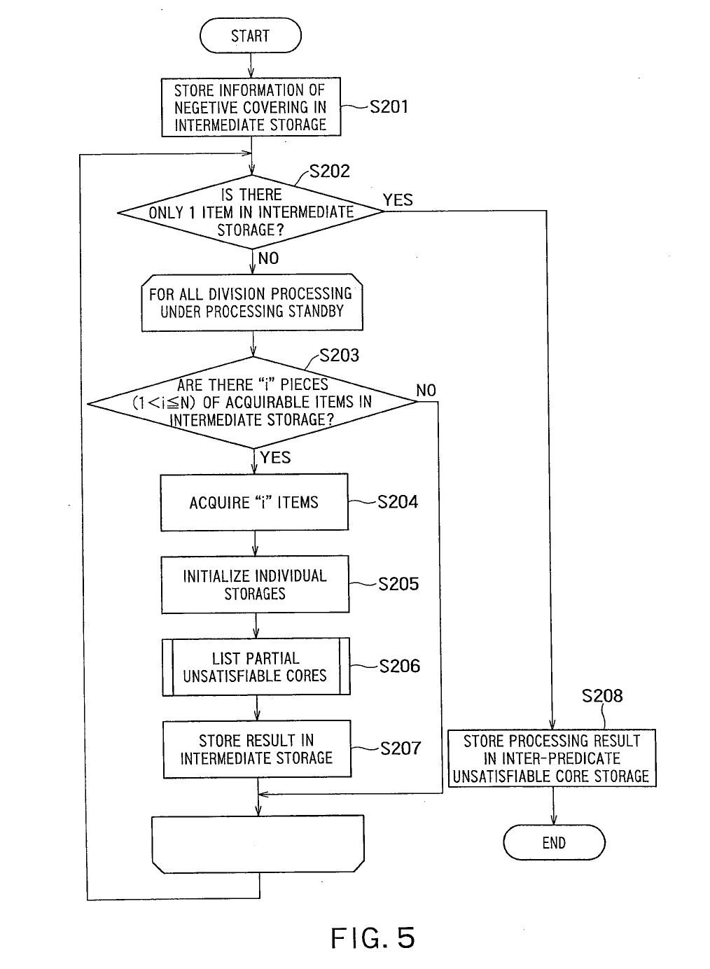

FIG. 4 illustrates a configuration of the inter-predicate unsatisfiable core lister 24. Also, FIG. 5 illustrates a flowchart illustrating a flow of processing of the inter-predicate unsatisfiable core lister 24. While there are two division processors A and B in FIG. 4, there may be only one division processor or there may be three or more division processors. When there are two or more division processors, since parallel processing can be performed, there is a case that the processing can be accelerated.

The example to be described below illustrates the case of using only the division processor A as a result.

(Step S201 in FIG. 5) A division integrator 52 of the inter-predicate unsatisfiable core lister 24 reads information in the negative covering storage 32, generates an item composed of the following three for each negative covering set, and stores it in an intermediate result storage 53.
No. of the negative covering set
Configuration information (unsatisfiable core) of the negative covering set
Mark of processability

“Mark of processability” is a mark indicating whether or not the item can be processed (that is, can be selected).

The division integrator 52 creates one item for each negative covering set. In each item, as described above, the No. of the negative covering set, the configuration information (unsatisfiable core) of the negative covering set, and an initial value of the mark of processability are included.

In this example, contents of the intermediate result storage 53 are turned to a state illustrated in FIG. 16. They are “the No. of the negative covering set”, “the configuration information (unsatisfiable core) of the negative covering set”, and “the mark of processability” from the left. “OK” is the mark indicating that the processing is possible. Also, “NG” indicates that the processing is impossible.

(Step S202 in FIG. 5) The division integrator 52 discriminates whether or not the number of the items stored in the intermediate result storage 53 is only 1. In the case of only 1 item, a determination result is YES, and the configuration information (unsatisfiable core) of the negative covering set described in the 1 item in the intermediate result storage 53 is stored in an inter-predicate unsatisfiable core storage 34 (S208). In the case that two or more items are stored, the determination result is NO, and the processing advances to step S203. In the above-described example, since three items are stored in the intermediate result storage 53 at the point of time, the determination result is NO. Therefore, the processing advances to step S203.

(Step S203 in FIG. 5) Of the division processors A and B, the division processor under processing standby is used to perform the subsequent processing in parallel. At the point of time (initial state), both of the two division processors are under the processing standby. Being under the processing standby means that it is in a utilizable state.

First, for the division processor A under the processing standby, whether or not there are “i” pieces (1<i≦N pieces) of processable items in the intermediate result storage 53 is determined. “N” is defined as 2 here. The value is preset to the device by a user. The processable item is the item for which “the mark of processability” is “OK”. Since N=2, “i” that satisfies 1<i≦N is only i=2. “N” needs to be equal to or larger than 2 and is equal to or smaller than the number (3, in this example) of the negative covering set.

At the present point of time, since there are three processable items in the intermediate result storage 53 (YES in S203), the processing advances to step S204. When there are not “i”processable items (NO in S203), the processing to the division processor is ended.

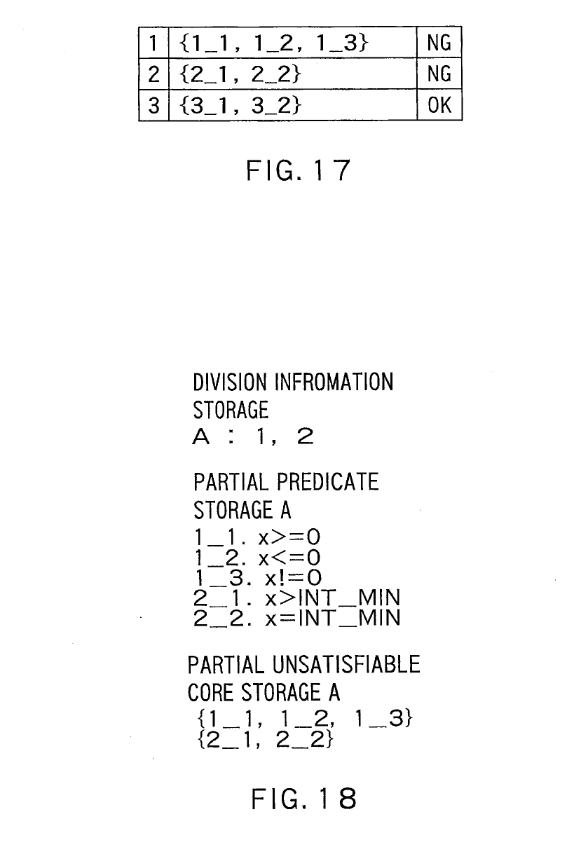

(Step S204 in FIG. 5) The division integrator 52 makes the division processor A acquire N=2 items among the processable items from the intermediate result storage 53. Here, it is assumed that an item 1 and an item 2 (see FIG. 16) in the intermediate result storage 53 are acquired. The division integrator 52 turns the state (“the mark of processability”) of the items 1 and 2 to “NG (acquisition impossible)”. As a result, the contents of the intermediate result storage 53 are turned to that in FIG. 17. Simultaneously, in a division information storage 51, it is recorded that the item 1 and the item 2 are acquired by the division processor A.

In the meantime, for the division processor B capable of the processing, there is only one processable item (item of “OK”) among the items present in the intermediate result storage 53 (NO in S203). Therefore, since a condition of 1<i≦N is not satisfied, the division processor B ends the processing of the first time (a loop of the first time) without performing particular processing.

(Step S205 in FIG. 5) The division processor A successively initializes individual storages (a partial predicate storage A, a number storage A, and a partial unsatisfiable core storage A) of the division processor A.

First, in the partial predicate storage A, five predicates “1_{—}1”, “1_{—}2”, “1_{—}3”, “2_{—}1”, and “2_{—}2” included in the two items acquired from the intermediate result storage 53 are stored.

Further, in the number storage A, the number of the negative covering sets included in the acquired items is recorded. In this case, it is 2.

Furthermore, in the partial unsatisfiable core storage A, the predicate groups belonging to the negative covering sets included in the individual acquired items are stored. In this case, they are the two of {1_{—}1, 1_{—}2, 1_{—}3} and {2_{—}1, 2_{—}2}.

The contents of the division information storage 51, the partial predicate storage A, and the partial unsatisfiable core storage A at the point of time are as in FIG. 18.

(Step S206 in FIG. 5) A partial unsatisfiable core lister A of the division processor A lists the unsatisfiable cores (inter-predicate unsatisfiable cores), on the basis of the individual predicates stored in the partial predicate storage A.

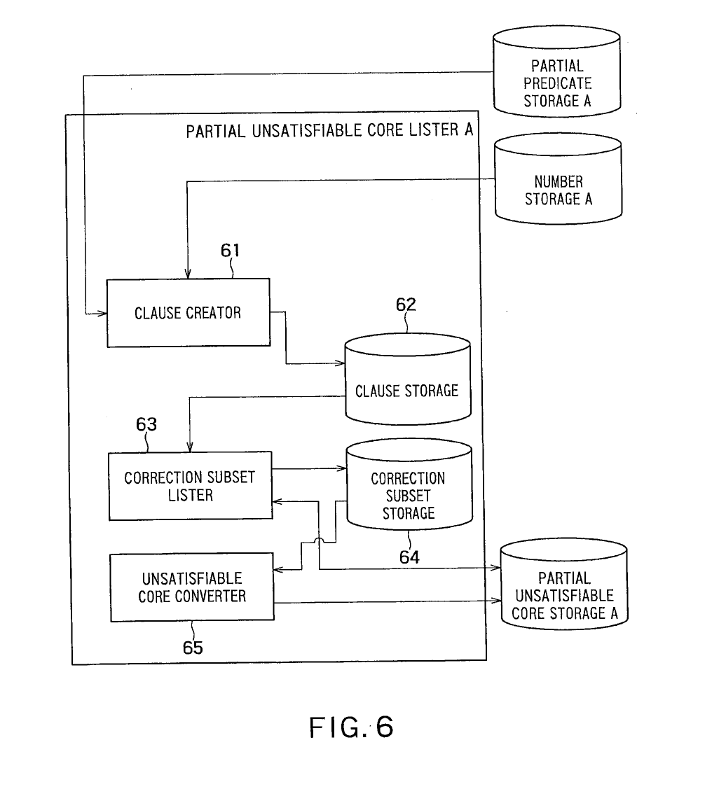

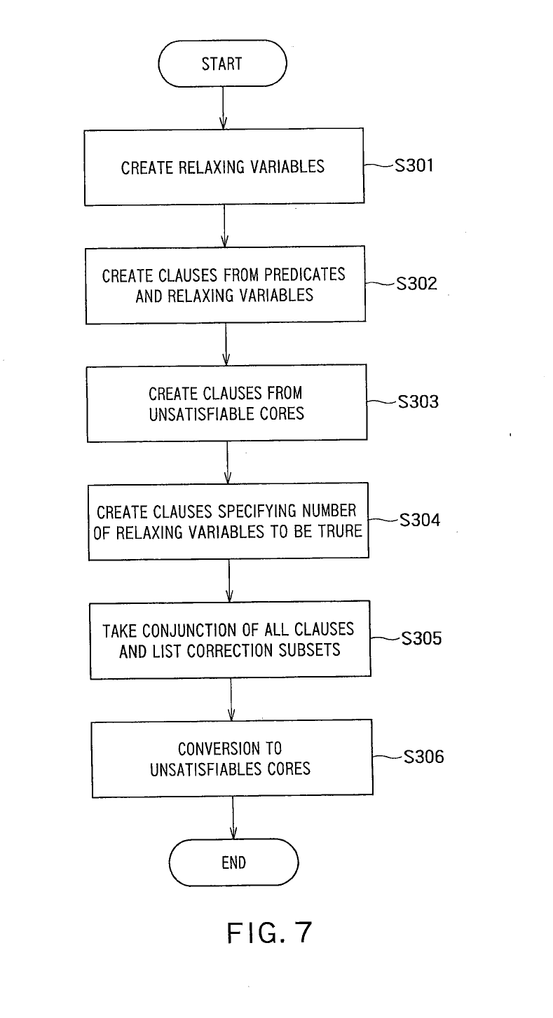

FIG. 6 illustrates a specific configuration of the partial unsatisfiable core lister A. Also, FIG. 7 illustrates a flow of the processing of the partial unsatisfiable core lister A. Also, since a partial unsatisfiable core lister B of the division processor B has the configuration in FIG. 6 and performs the operation illustrated in FIG. 7, only the partial unsatisfiable core lister A will be described below, and the description of the partial unsatisfiable core lister B is omitted.

(Step S301 in FIG. 7) First, a clause creator 61 of the partial unsatisfiable core lister A creates variables in 1-to-1 correspondence with the individual predicates stored in the partial predicate storage A for the number of the predicates. The variable has a true or false value. Hereinafter, the variable is called a “relaxing variable”. Here, five relaxing variables “r1_{—}1”, “r1_{—}2”, “r1_{—}3”, “r2_{—}1”, and “r2_{—}2” corresponding to the five predicates “1_{—}1”, “1_{—}2”, “1_{—}3”, “2_{—}1”, and “2_{—}2” (see FIG. 18) are created.

(Step S302 in FIG. 7) Next, the clause creator 61 creates a clause (predicate selecting clause) by the disjunction (v) of the predicate and the relaxing variable corresponding to it. The clause means a part of the logical formula. The clause creator 61 stores the created predicate selecting clause in a clause storage 62. Here, the following five predicate selecting clauses are created. In each predicate selecting clause, it is meant that, if the relaxing variable is true, the predicate combined with the relaxing variable may be false (may not be selected).

(x>=0 [symbol] r1_{—}1)

(x<=0 [symbol] r1_{—}2)

(x!=0 [symbol] r1_{—}3)

(x>INT_MIN [symbol] r2_{—}1)

(x=INT_MIN [symbol] r2_{—}2)

(Step S302 in FIG. 7) Further, the clause creator 61 creates a different clause (relaxing selecting clause) for each negative covering set in the partial unsatisfiable core storage A, by taking the disjunction of the relaxing variables corresponding to the individual predicates belonging thereto. The clause creator 61 stores the relaxing selecting clause created for each negative covering set in the clause storage 62.

Here, the two negative covering sets {1_{—}1, 1_{—}2, 1_{—}3} and {2_{—}1, 2_{—}2} are stored in the partial unsatisfiable core storage A. Therefore, from the two negative covering sets, the following two relaxing selecting clauses are created respectively.
(r1_{—}1 [symbol] r1_{—}2 [symbol] r1_{—}3)
(r2_{—}1 [symbol] r2_{—}2)
(r1_{—}1 [symbol] r1_{—}2 [symbol] r1_{—}3) means a constraint that at least one of “r1_{—}1”, “r1_{—}2” and “r1_{—}3” is true and the remaining can be false.

(r2_{—}1 [symbol] r2_{—}2) means a constraint that at least one of “r2_{—}1” and “r2_{—}2” is true and the remaining can be false.

(S304 in FIG. 7) Further, on the basis of number information stored in the number storage A, the clause creator 61 creates a clause (number specifying clause) that specifies the number of the relaxing variables to be equal to or smaller than the number (or the same value as the number). The presence of the clause functions as a constraint, and in the processing of a following correction subset lister 63, only relaxing variables for the number become true and the remaining relaxing variables become false. The processing of specifying the number of the variables to be true like this is the known technology in the literature (Zhaohui Fu, S Malik, “On solving the partial MAX-SAT problem”, Proceedings of the 9th international conference on Theory and Applications of Satisfiability Testing p. 252-265) or the like, and some methods are applicable.

In the present embodiment, the following processing is performed.

First, in the number storage A, “2” is stored as the number information. Then, two intermediate variables taking the true or false value corresponding to the individual relaxing variables are created, and a set of one intermediate variable of the individual relaxing variables and a set of the other intermediate variable are created. Here, first

intermediate variables s1_{—}1_{—}1, s2_{—}1_{—}1, for the relaxing variable r1_{—}1,

intermediate variables s1_{—}1_{—}2, s2_{—}1_{—}2, for the relaxing variable r1_{—}2,

intermediate variables s1_{—}1_{—}3, s2_{—}1_{—}3, for the relaxing variable r1_{—}3,

intermediate variables s1_{—}2_{—}1, s2_{—}2_{—}1, for the relaxing variable r2_{—}1, and

intermediate variables s1_{—}2_{—}2, s2_{—}2_{—}2, for the relaxing variable r2_{—}2, are generated. Then, from them, the following two sets of the intermediate variables are created.
(1) s1_{—}1_{—}1, s1_{—}1_{—}2, s1_{—}1_{—}3, s1_{—}2_{—}1, s1_{—}2_{—}2
(2) s2_{—}1_{—}1, s2_{—}1_{—}2, s2_{—}1_{—}3, s2_{—}2_{—}1, s2_{—}2_{—}2

Then, in each of the individual sets, three kinds of clauses that are “disjunction of all”, “disjunctions of arbitrary two negations”, and “disjunctions of one negation and the original relaxing variable” are created.

First, the following three kinds of clauses (a total of 16 clauses) are created from the set of “s1_{—}1_{—}1, s1_{—}1_{—}2, s1_{—}1_{—}3, s1_{—}2_{—}1, s1_{—}2_{—}2”.

The clause of the disjunction of all:
(s1_{—}1_{—}1 [symbol] s1_{—}1_{—}2 [symbol] s1_{—}1_{—}3 [symbol] s1_{—}2_{—}1 [symbol] s1_{—}2_{—}2)

The clauses of the disjunctions of arbitrary two negations:
( [symbol] s1_{—}1_{—}1 [symbol] [symbol] s1_{—}1_{—}2)
( [symbol] s1_{—}1_{—}1 [symbol] [symbol] s1_{—}1_{—}3)
( [symbol] s1_{—}1_{—}1 [symbol] [symbol] s1_{—}1_{—}4)
( [symbol] s1_{—}1_{—}1 [symbol] [symbol] s1_{—}1_{—}5)
( [symbol] s1_{—}1_{—}2 [symbol] [symbol] s1_{—}1_{—}3)
( [symbol] s1_{—}1_{—}2 [symbol] [symbol] s1_{—}1_{—}4)
( [symbol] s1_{—}1_{—}2 [symbol] [symbol] s1_{—}1_{—}5)
( [symbol] s1_{—}1_{—}3 [symbol] [symbol] s1_{—}1_{—}4)
( [symbol] s1_{—}1_{—}3 [symbol] [symbol] s1_{—}1_{—}5)
( [symbol] s1_{—}1_{—}4 [symbol] [symbol] s1_{—}1_{—}5) The clauses of the disjunctions of one negation and the original relaxing variable:
( [symbol] s1_{—}1_{—}1 [symbol] r1_{—}1)
( [symbol] s1_{—}1_{—}2 [symbol] r1_{—}2)
( [symbol] s1_{—}1_{—}3 [symbol] r1_{—}3)
( [symbol] s1_{—}1_{—}4 [symbol] r1_{—}4)
( [symbol] s1_{—}1_{—}5 [symbol] r1_{—}5)

Similarly for the set of “s2_{—}1_{—}1, s2_{—}1_{—}2, s2_{—}1_{—}3, s2_{—}2_{—}1, s2_{—}2_{—}2”, the following three kinds of clauses (a total of 16 clauses) are created.

The clause of the disjunction of all:
(s2_{—}1_{—}1 [symbol] s2_{—}1_{—}2 [symbol] s2_{—}1_{—}3 [symbol] s2_{—}2_{—}1 [symbol] s2_{—}2_{—}2) The clauses of the disjunctions of arbitrary two negations:
( [symbol] s2_{—}1_{—}1 [symbol] [symbol] s2_{—}1_{—}2)
( [symbol] s2_{—}1_{—}1 [symbol] [symbol] s2_{—}1_{—}3)
( [symbol] s2_{—}1_{—}1 [symbol] [symbol] s2_{—}1_{—}4)
( [symbol] s2_{—}1_{—}1 [symbol] [symbol] s2_{—}1_{—}5)
( [symbol] s2_{—}1_{—}2 [symbol] [symbol] s2_{—}1_{—}3)
( [symbol] s2_{—}1_{—}2 [symbol] [symbol] s2_{—}1_{—}4)
( [symbol] s2_{—}1_{—}2 [symbol] [symbol] s2_{—}1_{—}5)
( [symbol] s2_{—}1_{—}3 [symbol] [symbol] s2_{—}1_{—}4)
( [symbol] s2_{—}1_{—}3 [symbol] [symbol] s2_{—}1_{—}5)
( [symbol] s2_{—}1_{—}4 [symbol] [symbol] s2_{—}1_{—}5)

The clauses of the disjunctions of one negation and the original relaxing variable:
( [symbol] s2_{—}1_{—}1 [symbol] r1_{—}1)
( [symbol] s2_{—}1_{—}2 [symbol] r1_{—}2)
( [symbol] s2_{—}1_{—}3 [symbol] r1_{—}3)
( [symbol] s2_{—}1_{—}4 [symbol] r1_{—4})
( [symbol] s2_{—}1_{—}5 [symbol] r1_{—}5)

A total of 32 clauses are created in this way. The clause creator 61 also stores these 32 clauses in the clause storage 62.

When the conjunction of all the clauses stored in the clause storage 62 (the number specifying clauses (the above 32 clauses), the predicate selecting clauses, the relaxing selecting clauses) are taken, and a solution that makes the logical formula of the conjunction be true is obtained, the number of the relaxing variables to be true surely becomes two or smaller (actually, it coincides with two pieces due to a property of the negative covering set).

(Step S305 in FIG. 7) Next, the correction subset lister 63 takes the conjunction of all the clauses stored in the clause storage 62, and creates a logical formula “F1”. The correction subset lister 63 lists resolutions of the logical formula “F1”. One, two or more solutions are present. In each solution, the number of the relaxing variables to be true is two.

The correction subset lister 63 specifies the relaxing variable turned to be true in the solution, and obtains a set of the indexes of the predicates corresponding to the specified relaxing variable. The set obtained here is the minimal correction subset. It is because that the size of the minimal correction subset surely coincides with the number stored in the number storage A, that is, the number of the negative covering included in the logical formula “F1”. Therefore, specification of the number of the negative covering included in the logical formula “F1” is important in the present embodiment.

When the above-described number specifying clause is not present, from the definition of the correction subset, the number of the correction subsets to be obtained becomes equal to or larger than the number of the negative covering sets, however, by limiting the number of the relaxing variables to be true to 2 by the number specifying clause, the number of elements of the correction subset can be minimized. The correction subset lister 63 stores the correction subset obtained for each solution in a correction subset storage 64.

In this example, as the correction subsets, four of {1_{—}1, 2_{—}1}, {1_{—}1, 2_{—}2}, {1_{—}2, 2_{—}2}, and {1_{—}3, 2_{—}2} are obtained.

Here, for the processing of listing the solutions of the logical formula, well-known logical constraint solvers such as an SAT (satisfiability) solver or an SMT (SAT Modulo Theories) solver can be used. However, it is a condition that the solver capable of listing not only one but all is to be used when there are the plurality of solutions. In the present embodiment, it is possible to utilize kodkod (http://alloy.mit.edu/kodkod/) or the like for instance.

(Step S306 in FIG. 7) Next, an unsatisfiable core converter 65 converts a correction subset group stored in the correction subset storage 64 to an unsatisfiable core (predicate unsatisfiable core) group. The unsatisfiable core converter 65 stores the acquired unsatisfiable core group in the partial unsatisfiable core storage A. The contents originally stored in the partial unsatisfiable core storage A may be deleted by overwrite. Conversion from the correction subset group to the unsatisfiable core group may be performed using a known method.

It is known that relationship between the minimal correction subset group and the minimal unsatisfiable core group is equivalent to relationship between a DNF (disjunctive normal form) and a CNF (conjunctive normal form) of the logical formula according to the literatures below or the like. Related literatures are listed below.
Bailey, J. and P. J. Stuckey: 2005, ‘Discovery of Minimal Unsatisfiable Subsets of Constraints Using Hitting Set Dualization’. In: Proceedings of the 7th International Symposium on Practical Aspects of Declarative Languages (PADL′05), Vol. 3350 of LNCS.
Birnbaum, E. and E. L. Lozinskii: 2003, ‘Consistent subsets of inconsistent systems: structure and behaviour’. Journal of Experimental and Theoretical Artificial Intelligence 15, 25-46.
Liffiton, M. H., M. D. Moffitt, M. E. Pollack, and K. A. Sakallah: 2005, ‘Identifying Conflicts in Overconstrained Temporal Problems’. In: Proceedings of the 19th International Joint Conference on Artificial Intelligence (IJCAI′05). pp. 205-211.

Therefore, in conversion processing from the correction subset group to the unsatisfiable core group, it is possible to utilize many known technologies such as the method indicated in the paragraph 6.2 (pp. 15-17) of Non Patent Literature 2 for instance, or a known CNF/DNF conversion algorithm indicated in the literature (T Eiter, G Gottlob, K Makino, <<New results on monotone dualization and generating hypergraph transversals>>-SIAM Journal on Computing, 2003).

Here, by converting the previously obtained correction subset groups {1_{—}1, 2_{—}1}, {1_{—}1, 2_{—}2}, {1_{—}2, 2_{—}2}, and {1_{—}3, 2_{—}2}, the unsatisfiable core groups {1_{—}1, 1_{—}2, 1_{—}3}, {2_{—}1, 2_{—}2}, and {1_{—}1, 2_{—}2} are obtained. When it is liken to CNF/DNF conversion, from the previous correction subsets {1_{—}1, 2_{—}1}, {1_{—}1, 2_{—}2}, {1_{—}2, 2_{—}2}, and {1_{—}3, 2_{—}2}, all the conjunction of the disjunctions of the individual correction subsets are taken to form the logical formula (1_{—}1 [symbol] 2_{—}1) [symbol] (1_{—}1 [symbol] 2_{—}2) [symbol] (1_{—}2 [symbol] 2_{—}2) [symbol] (1_{—}3 [symbol] 2_{—}2). The logical formula is converted to an equivalent DNF logical formula (1_{—}1 [symbol] 1_{—}2 [symbol] 1_{—}3) [symbol] (2_{—}1 [symbol] 2_{—}2) [symbol] (1_{—}1 [symbol] 2_{—}2). Thereafter, when the symbols included in the individual clause of the DNF logical formula are turned to one set, {1_{—}1, 1_{—}2, 1_{—}3}, {2_{—}1, 2_{—}2}, and {1_{—}1, 2_{—}2} are obtained. They are the unsatisfiable cores obtained in the unsatisfiable core converter 65, respectively.

While the case of converting the correction subset to the unsatisfiable core is indicated above, in the case of directly obtaining the unsatisfiable core, for instance, in the simplest way, the clauses that cannot be made true simultaneously in the logical formula including the conjunction of (x>=0 [symbol] r1_{—}1)(x<=0 [symbol] r1_{—}2)(x!=0 [symbol] r1_{—}3)(x>INT_MIN [symbol] r2_{—}1)(x=IN T_MIN [symbol] r2_{—}2) are obtained, and the set of the predicates included in the specified clauses can be obtained as the unsatisfiable core. For instance, when the solution that (x>=0 [symbol] r1_{—}1) and (x=INT_MIN [symbol] r2_{—}2) cannot be simultaneously made true as one of the solutions, {x>=0, x=INT_MIN}, that is, {1_{—}1, 2_{—}2} is obtained as one of the unsatisfiable cores.

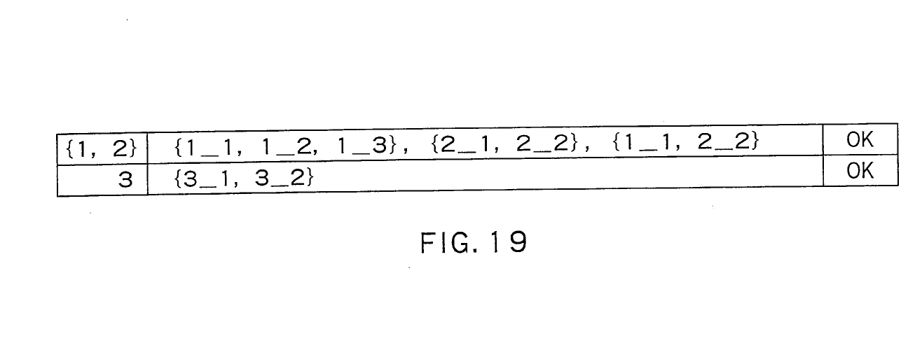

With that, unsatisfiable core listing in the division processor A is ended, so that the intermediate result storage 53 is updated on the basis of the result (step S207 in FIG. 5). Specifically, the intermediate result storage 53 creates an item for which negative covering indexes of the two items acquired by the division processor A, adds the unsatisfiable core (inter-predicate unsatisfiable core) stored in the partial unsatisfiable core storage A to a column of the unsatisfiable core of the item, and adds the mark “OK” indicating that the processing is possible to a column of the mark of processability. The two items acquired by the division processor A are deleted from the intermediate result storage 53. Thus, the state of the intermediate result storage 53 becomes like FIG. 19. The first column of the first row is a result of merging the negative covering indexes of the original items 1 and 2. In the second column of the first row, the unsatisfiable core (inter-predicate unsatisfiable core) stored in the partial unsatisfiable core storage A is recorded. The third column is set to the mark “OK” indicating that the processing is possible.

Since steps S203-S207 in FIG. 5 are ended for the two division processors A and B, the division integrator 52 returns to step S202 and repeats the same processing again. First, whether or not the number of the items stored in the intermediate result storage 52 is only 1 is discriminated. Since there are 2 pieces here, it is determined as NO, and the processing advances to step S203. The division processors A and B are both in a state that the processing is possible.

(Step S203 in FIG. 5) The division integrator 52 determines whether or not there are “i” pieces (the number larger than 1 and is equal to or smaller than “N” (=2)) of the processable items (the number of the items of “OK”) in the intermediate result storage 53, for the division processor A. Since there are two pieces at the present point of time (see FIG. 19), the determination is YES. Therefore, the two items, that is, the item {1, 2} and the item 3, are acquired from the intermediate result storage 53 and delivered to the division processor A (S204). The division integrator 52 attaches the mark “NG” indicating the acquisition is impossible to the two items in the intermediate result storage 53. Also, the division integrator 52 records in the division information storage 51 that the item {1, 2} and the item 3 are delivered to the division processor A.

In the meantime, for the division processor B, there is no processable item in the intermediate result storage 53 (both of the item {1, 2} and the item 3 are “NG”). Therefore, the division integrator 52 ends the processing of the second time without performing particular processing to the division processor B (NO in S203).

(Step S205 in FIG. 5) The division processor A initializes the individual storages. First, the division processor A stores seven predicates “1_{—}1”, “1_{—}2”, “1_{—}3”, “2_{—}1”, “2_{—}2”, “3_{—}1”, and “3_{—}2” included in the two items acquired from the division integrator 52 in the partial predicate storage A. Further, the division processor A records the number of the negative covering sets acquired from the division integrator 52. In this case, it is 3 (in the item {1, 2} and the item 3, three negative covering sets 1, 2, and 3 are included). Then, further, the division processor A stores the unsatisfiable cores in the items acquired from the division integrator 52 in the partial unsatisfiable core storage A. In this case, the four unsatisfiable cores of {1_{—}1, 1_{—}2, 1_{—}3}, {2_{—}1, 2_{—}2}, {1_{—}1, 2_{—}2} and {3_{—}1, 3_{—}2} are stored in the partial unsatisfiable core storage A.

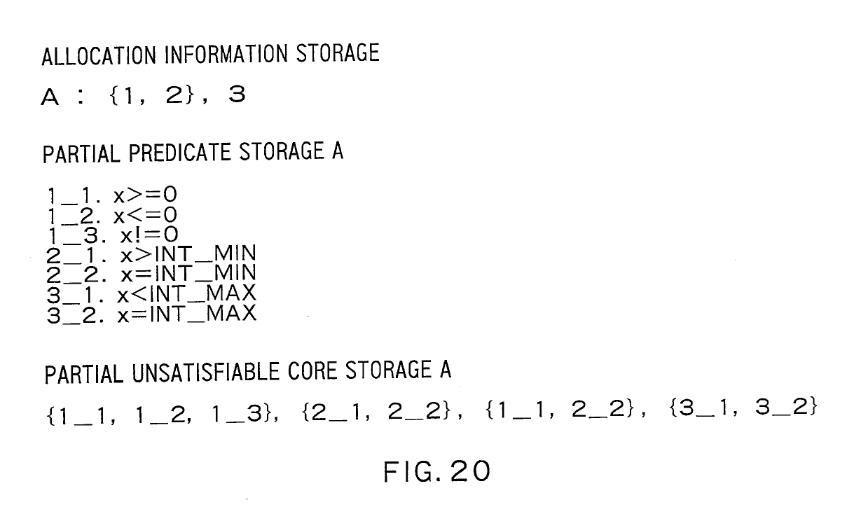

The contents of the division information storage 51, the partial predicate storage A, and the partial unsatisfiable core storage A at the point of time are illustrated in FIG. 20.

(Step S206 in FIG. 5) The partial unsatisfiable core lister A of the division processor A lists the unsatisfiable cores.

(Step S301 in FIG. 7) It is performed similarly to the processing of the first time, and the clause creator 61 first creates the seven relaxing variables “r1_{—}1”, “r1_{—}2”, “r1_{—}3”, “r2_{—}1”, “r2_{—}2”, “r3_{—}1”, and “r3_{—}2” corresponding to the seven predicates stored in the partial predicate storage A.

(Step S302 in FIG. 7) Next, the clause creator 61 creates the following seven clauses (predicate selecting clauses) from the seven predicates and the seven relaxing variables corresponding to the predicates. The clause creator 61 stores the created seven clauses (predicate selecting clauses) in the clause storage 62.
(x>=0 [symbol] r1_{—}1)
(x<=0 [symbol] r1_{—}2)
(x!=0 [symbol] r1_{—}3)
(x>INT_MIN [symbol] r2_{—}1)
(x=INT_MIN [symbol] r2_{—}2)
(x>INT_MAX [symbol] r3_{—}1)
(x=INT_MAX [symbol] r3_{—}2)

(Step S303 in FIG. 7) Also, the clause creator 61 creates the following four clauses (relaxing selecting clauses) for the four unsatisfiable cores stored in the partial unsatisfiable core storage A. The clause creator 61 stores the created four clauses (relaxing selecting clauses) in the clause storage 62.
(r1_{—}1 [symbol] r1_{—}2 [symbol] r1_{—}3)
(r2_{—}1 [symbol] r2_{—}2)
(r1_{—}1 [symbol] r2_{—}2)
(r3_{—}1 [symbol] r3_{—}2)

(Step S304 in FIG. 7) Further, the clauses (number specifying clauses) that specify the number of the relaxing variables to be true to be equal to or smaller than three are created. For a creation method, the above-described method may be used. Concrete examples of the clauses to be created are omitted since there are too many. The clause creator 61 stores the created number specifying clauses in the clause storage 62.

(S305 in FIG. 7) Then, the correction subset lister 63 takes the conjunction of all the clauses stored in the clause storage 62 and generates a logical formula “F2”. The correction subset lister 63 lists the solutions of the generated logical formula “F2”. In each individual solution, the set of the predicates corresponding to the relaxing variable that is made true is acquired as the correction subset, respectively. Here, the five correction subsets of {1_{—}1, 2_{—}1, 3_{—}2}, {1_{—}1, 2_{—}2, 3_{—}2}, {1_{—}2, 2_{—}2, 3_{—}1}, {1_{—}2, 2_{—}2, 3_{—}2}, and {1_{—}3, 2_{—}2, 3_{—}2} are obtained. The correction subset lister 63 stores these five correction subsets in the correction subset storage 64.

(Step S306 in FIG. 7) Next, the unsatisfiable core converter 65 converts the correction subset group inside the correction subset storage 64 to the unsatisfiable core group. Here, the six unsatisfiable cores of {1_{—}1, 1_{—}2, 1_{—}3}, {2_{—}1, 2_{—}2}, {1_{—}1, 2_{—}2}, {3_{—}1, 3_{—}2}, {1_{—}2, 3_{—}2}, and {2_{—}2, 3_{—}2} are obtained. The unsatisfiable core converter 65 stores these six unsatisfiable cores in the partial unsatisfiable core storage A. The contents originally stored in the partial unsatisfiable core storage A may be deleted by overwrite.

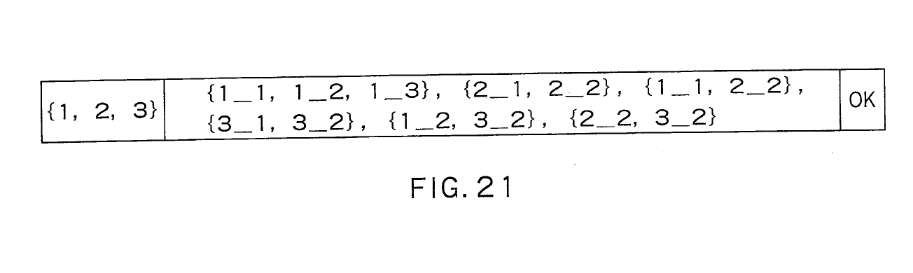

Since the processing of the division processors A and B is ended, the division integrator 52 updates the contents of the intermediate result storage 53 on the basis of the contents of the partial unsatisfiable core storage A, similarly to the processing of the first time. As the result of update, the contents of the intermediate result storage 53 are turned to the state that only one item is stored as illustrated in FIG. 21.

(Step S202 in FIG. 5) Then, the division integrator 52 confirms the number of the items stored in the intermediate result storage 53. Since the number of the items here is 1, YES is determined, and the processing advances to step S208.

(Step S208 in FIG. 5) The division integrator 52 takes out the unsatisfiable core group (inter-predicate unsatisfiable core group) included in the only one item stored in the intermediate result storage 53, and stores it in the inter-predicate unsatisfiable core storage 34. In the inter-predicate unsatisfiable core storage, the six inter-predicate unsatisfiable cores of {1_{—}1, 1_{—}2, 1_{—}3}, {2_{—}1, 2_{—}2}, {1_{—}1, 2_{—}2}, {3_{—}1, 3_{—}2}, {1_{—}2, 3_{—}2}, and {2_{—}2, 3_{—}2} are stored. With that, the processing of the inter-predicate unsatisfiable core lister 24 is ended.

A whole unsatisfiable core lister 25 in FIG. 1 lists the unsatisfiable cores on the basis of the inter-predicate unsatisfiable cores stored in the inter-predicate unsatisfiable core storage 34, the program logical formula stored in the program logical formula storage 33, the additional constraint (the negation of the postcondition, here) set by the additional constraint setter 13, and the predicate group stored in the predicate storage 31.

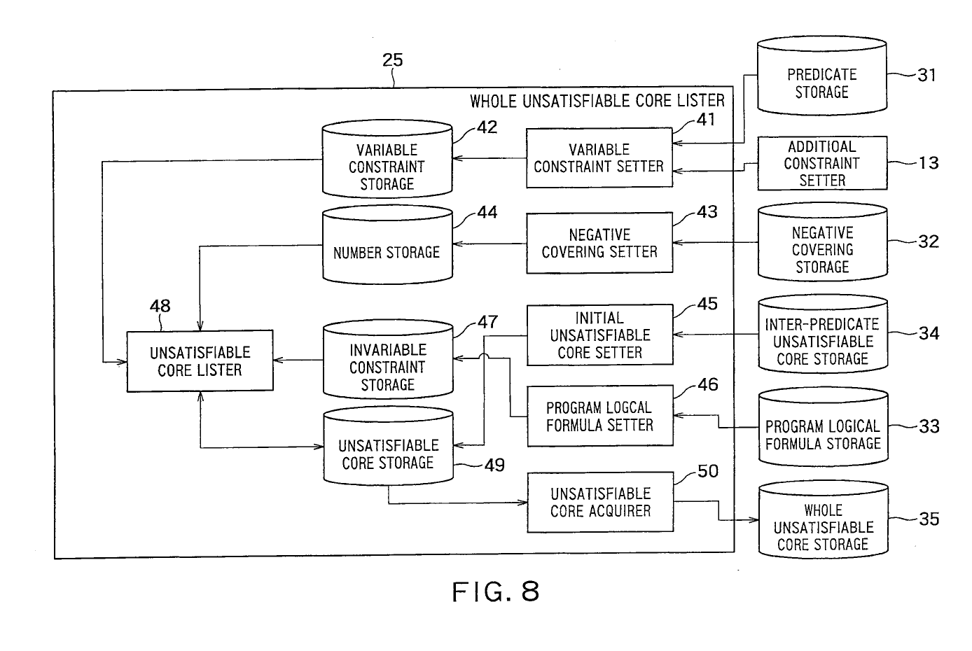

FIG. 8 illustrates a specific configuration example of the whole unsatisfiable core lister 25.

An initial unsatisfiable core setter 45 stores all the inter-predicate unsatisfiable cores stored in the inter-predicate unsatisfiable core storage 34 in an unsatisfiable core storage 49. Here, as illustrated in FIG. 21, six unsatisfiable cores (inter-predicate unsatisfiable cores) are stored in the unsatisfiable core storage 49.

A negative covering setter 43 adds 1 to the number of the negative covering sets stored in the negative covering storage 32, and stores a value after addition to a number storage 44. The addition of 1 in such a manner is performed since the size of the correction subsets listed in an unsatisfiable core lister 48 to be described later is surely the same as the number of the negative covering sets or equal to the number for which 1 (in the case that the additional constraint (the negation of the postcondition) is true) is added thereto. Here, since the number of the negative covering sets is 3 as illustrated at the lower part of FIG. 15, 4 for which 1 is added to 3 is stored in the number storage 44.

Also, a program logical formula setter 46 reads the program logical formula “Ps” stored in the program logical formula storage 33, and stores it in an invariable constraint storage 47.

Also, a variable constraint setter 41 reads all the predicates stored in the predicate storage 31, and stores them in a variable constraint storage 42. Here, as illustrated at the upper part in FIG. 15, seven predicates are stored in the variable constraint storage 42. Also, the variable constraint setter 41 acquires the additional constraint (the negation of the postcondition) set by the additional constraint setter 13, and stores it in the variable constraint storage 42.

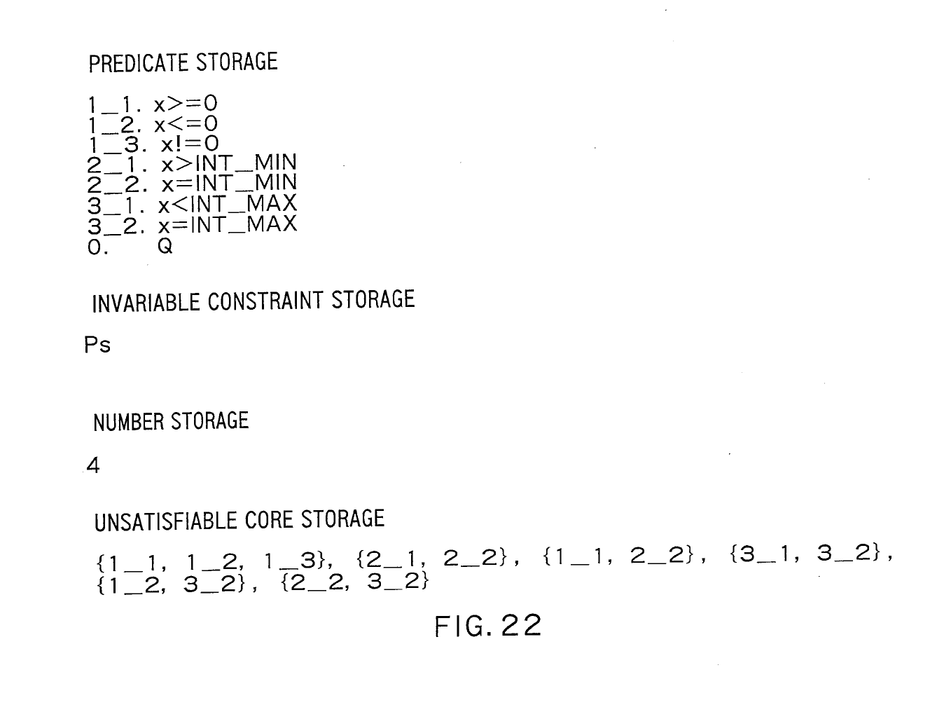

By initialization processing described above, states of the individual storages 42, 44, 47 and 49 are turned to those in FIG. 22.

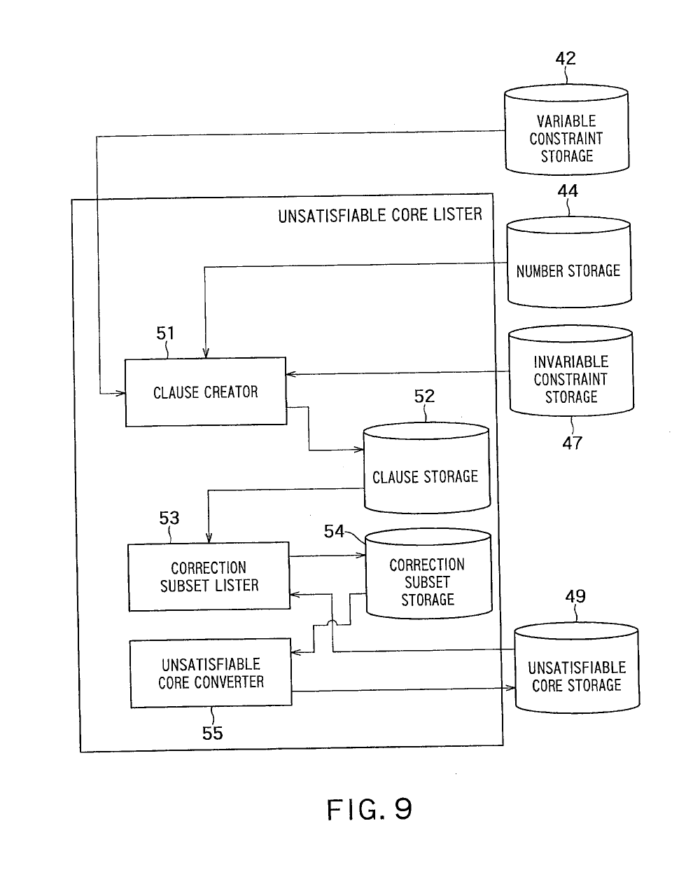

Next, an unsatisfiable core lister 48 of the whole unsatisfiable core lister 25 lists the unsatisfiable cores. FIG. 9 illustrates a configuration of the unsatisfiable core lister 48.

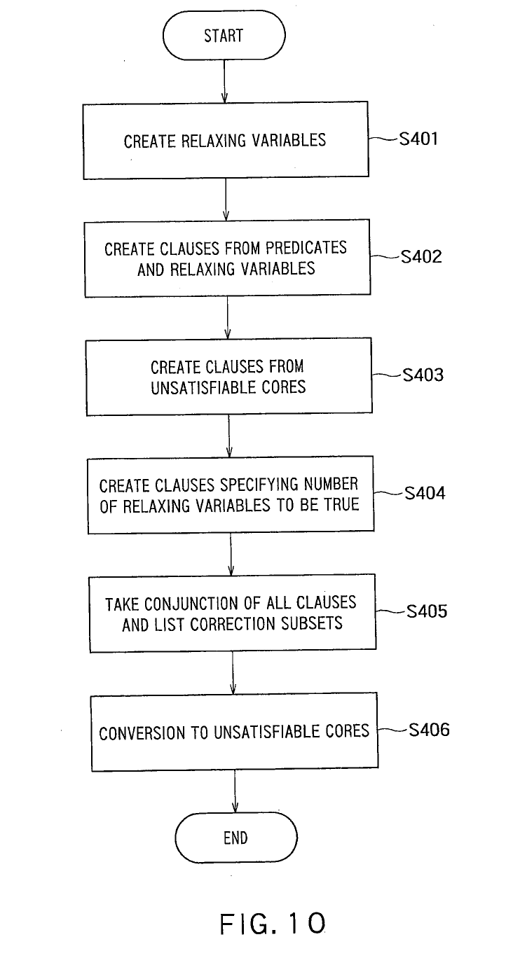

FIG. 10 illustrates a flowchart of the processing of the unsatisfiable core lister 48.

(Step S401 in FIG. 10) A clause creator 51 first creates the relaxing variables “r1_{—}1”, “r1_{—}2”, “r1_{—}3”, “r2_{—}1”, “r2_{—}2”, “r3_{—}1”, and “r3_{—}2” corresponding to the seven predicates stored in the variable constraint storage 42, also allocates an index “0” to the additional constraint (the negation of the postcondition) stored in the variable constraint storage 42, and creates a corresponding relaxing variable “r0”. That is, a total of eight relaxing variables are created.

(Step S402 in FIG. 10) The clause creator 51 creates the following clauses (the predicate selecting clauses and an additional constraint selecting clause) by the disjunctions of the predicates and the relaxing variables and the disjunctions of the additional constraint and the relaxing variable. The clause creator 51 stores the created clauses (the predicate selecting clauses and the additional constraint selecting clause) in the clause storage 52.
(x>=0 [symbol] r1_{—}1)
(x<=0 [symbol] r1_{—}2)
(x!=0 [symbol] r1_{—}3)
(x>INT_MIN [symbol] r2_{—}1)
(x=INT_MIN [symbol] r2_{—}2)
(x>INT_MAX [symbol] r3_{—}1)
(x=INT_MAX [symbol] r3_{—}2)
(Q [symbol] r0)

(Step S403 in FIG. 10) The clause creator 51 creates the following clauses (relaxing selecting clauses) on the basis of the six unsatisfiable cores (inter-predicate unsatisfiable cores) stored in the unsatisfiable core storage 49. The clause creator 51 stores the created relaxing selecting clauses in the clause storage 52.
(r1_{—}1 [symbol] r1_{—}2 [symbol] r1_{—}3)
(r2_{—}1 [symbol] r2_{—}2)
(r1_{—}1 [symbol] r2_{—}2)
(r3_{—}1 [symbol] r3_{—}2)
(r1_{—}2 [symbol] r3_{—}2)
(r2_{—}2 [symbol] r3_{—}2)

(Step S404 in FIG. 10) The clause creator 51 creates the clauses (number specifying clauses) that specify the number of the relaxing variables to be true to be equal to or smaller than four among the eight relaxing variables (“r1_{—}1”, “r1_{—}2”, “r1_{—}3”, “r2_{—}1”, “r2_{—}2”, “r3_{—}1”, “r3_{—}2”, “r0”). For the creation method, the above-described method may be used. For the number specifying clauses, since the number of the clauses is large, notations are omitted (they are noted as “Z”). The clause creator 51 stores the created number specifying clauses in the clause storage 52.

Further, the clause creator 51 stores the program logical formula “Ps” stored in the invariable constraint storage 47 in the clause storage 52 as a clause as it is.

(Step S405 in FIG. 10) A correction subset lister 53 takes the conjunction of all the clauses stored in the clause storage 52 and creates a logical formula “F3”. That is, the logical formula “F3” for which the conjunction of all the following clauses are taken is generated.
Ps
Q
z
(x>=0 [symbol] r1_{—}1)
(x<=0 [symbol] r1_{—}2)
(x!=0 [symbol] r1_{—}3)
(x>INT_MIN [symbol] r2_{—}1)
(x=INT_MIN [symbol] r2_{—}2)
(x>INT_MAX [symbol] r3_{—}1)
(x=INT_MAX [symbol] r3_{—}2)
(Q [symbol] r0)
(r1_{—}1 [symbol] r1_{—}2 [symbol] r1_{—}3)
(r2_{—}1 [symbol] r2_{—}2)
(r1_{—}1 [symbol] r2_{—}2)
(r3_{—}1 [symbol] r3_{—}2)
(r1_{—}2 [symbol] r3_{—}2)
(r2_{—}2 [symbol] r3_{—}2)

The correction subset lister 53 lists the solutions of the created logical formula “F3”. For each solution, the set of the predicates corresponding to the relaxing variables that are made true is acquired as the correction subset (whole correction subset). The correction subset lister 53 stores the individual acquired correction subsets in a correction subset storage 54. Here, the five correction subsets of {1_{—}1, 2_{—}1, 3_{—}2}, {0, 1_{—}1, 2_{—}2, 3_{—}2}, {0, 1_{—}2, 2_{—}2, 3_{—}1}, {0, 1_{—}2, 2_{—}2, 3_{—}2}, and {0, 1_{—}3, 2_{—}2, 3_{—}2} are stored in the correction subset storage 54.

(Step S406) An unsatisfiable core converter 55 converts the correction subset group stored in the correction subset storage 54 to the unsatisfiable core group. The unsatisfiable core converter 55 stores the generated unsatisfiable core group in the unsatisfiable core storage 49. Here, the eight unsatisfiable cores of {1_{—}1, 1_{—}2, 1_{—}3}, {2_{—}1, 2_{—}2}, {1_{—}1, 2_{—}2}, {3_{—}1, 3_{—}2}, {1_{—}2, 3_{—}2}, {2_{—}2, 3_{—}2}, {0, 1_{—}1}, {0, 2_{—}1}, and {0, 3_{—}2} are generated. These unsatisfiable cores are stored in the unsatisfiable core storage 49. The contents originally stored in the unsatisfiable core storage 49 may be deleted by overwrite.

With that, the processing of the unsatisfiable core lister 48 in FIG. 8 is ended.

The unsatisfiable core lister 48 performs the processing (see FIG. 7) almost similar to that of the partial unsatisfiable core lister (see FIG. 6) described above. Therefore, the unsatisfiable core lister 48 may be configured so as to be shared with the partial unsatisfiable core lister and the unsatisfiable core lister and the partial unsatisfiable core lister may be gathered into one. In this case, the variable constraint storage 42 in FIG. 9 corresponds to the partial predicate storage in FIG. 6. Also, there is input from the invariable constraint storage 47 in the unsatisfiable core lister 48 in FIG. 9, however, there is no input from the invariable constraint storage 47 in the partial unsatisfiable core lister in FIG. 6. Therefore, during the operation of listing the partial unsatisfiable cores, the contents of the invariable constraint storage 47 may be turned empty to perform the processing. This will be described in detail later as a modification 1.

An unsatisfiable core acquirer 50 reads the unsatisfiable core group stored inside the unsatisfiable core storage 49, and stores it as it is in a whole unsatisfiable core storage 35. With that, the processing of the whole unsatisfiable core lister 25 is ended.

A specification deriver 26 in FIG. 1 generates the specification (precondition) on the basis of the unsatisfiable core group stored in the whole unsatisfiable core storage 35. First, the specification deriver 26 specifies only the ones including the index “0” equivalent to the additional constraint in the unsatisfiable core group stored in the whole unsatisfiable core storage 35.

Among {1_{—}1, 1_{—}2, 1_{—}3}, {2_{—}1, 2_{—}2}, {1_{—}1, 2_{—}2}, {3_{—}1, 3_{—}2}, {1_{—}2, 3_{—}2}, {2_{—}2, 3_{—}2}, {0, 1_{—}1}, {0, 2_{—}1}, and {0, 3_{—}2}, the three that are {0, 1_{—}1}, {0, 2_{—}1}, and {0, 3_{—}2} include the index “0”. Therefore, these three unsatisfiable cores are specified.

Next, the specification deriver 26 eliminates the index “0” equivalent to the additional constraint from the individual specified unsatisfiable cores, and also replaces the other index with the original predicate.

When the index “0” is eliminated from {0, 1_{—}1}, it is {1_{—}1}, and when the index “1_{—}1” is replaced with “x>=0” (see FIG. 22), {x>=0} is obtained.

When the index “0” is eliminated from {0, 2_{—}1}, it is {2_{—}1}, and when the index “2_{—}1” is replaced with “x>INT_MIN” (see FIG. 22), {x>INT_MIN} is obtained.

When the index “0” is eliminated from {0, 3_{—}2}, it is {3_{—}2}, and when the index “3_{—}2” is replaced with “x=INT_MAX” (see FIG. 22), {x=INT_MAX} is obtained.

Thus, the three sets of {x>=0}, {x>INT_MIN}, and {x=INT_MAX} are obtained. While the individual sets are constituted of only a single predicate in this example, generally the plurality of predicates can configure one set.

For each of the sets obtained in this way, the specification deriver 26 takes the conjunction of all the elements and generates one logical formula. As a result, the following three logical formulas are obtained.
x>=0
x>INT_MIN
x=INT_MAX

All of the three logical formulas become the preconditions to the program set to the program setter 14 by the user first and the postcondition (the one for which the negation “!” is removed from the additional constraint illustrated in FIG. 12) included in the additional constraint set to the additional constraint setter 13.

The specification deriver 26 delivers the generated specifications (three preconditions) to a specification presenter 12. The specification presenter 12 displays the specifications delivered from the specification deriver 26 on a screen of a display device. Thus, the specifications are presented to the user. The specification presenter 12 may preserve the specifications delivered from the specification deriver 26 in a storage device such as a hard disk or a memory device. Also, the specification presenter 12 may transmit the specifications through a network to another device.

In the above-described example, the disjunction (Qνr0) of the additional constraint “Q” and the relaxing variable is included in the logical formula “F3”, however, a configuration of removing the disjunction (Qνr0) from the logical formula is also possible. In this case, the number specifying clause is also changed so as to specify three instead of four. Since the solutions are listed with the constraint that “Q” is always true, the unsatisfiable core converted from the correction subset does not include the additional constraint (index “0”). That is, the unsatisfiable core after the conversion is the minimal set (set size is 1 or larger) of the predicates that cannot be made true simultaneously with the additional constraint in the case of obtaining the solution that makes the logical formula for which the conjunction of the program logical formula and the additional constraint is taken be true.

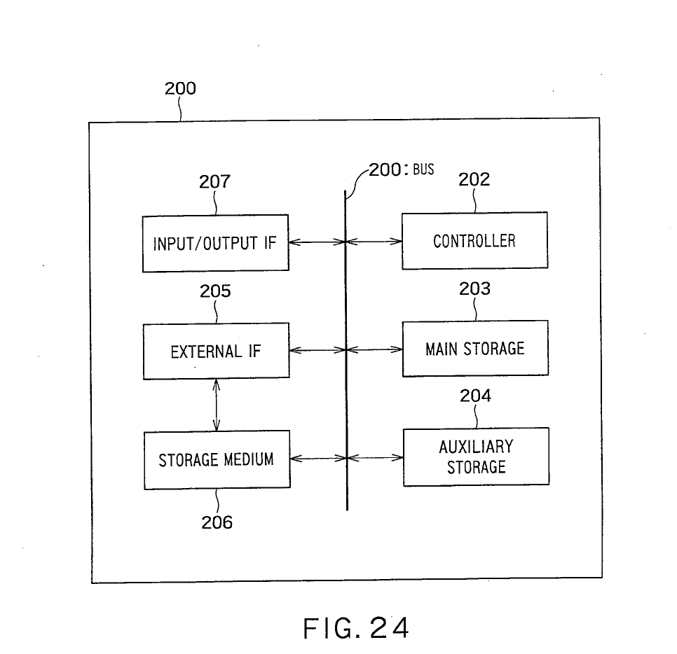

The system illustrated in FIG. 1 can be realized also by using a general purpose computer device as basic hardware as illustrated in FIG. 24, for instance. In this computer device 200, a controller (circuitry such as a processor or a processing system including a plurality of processors) 202, a main storage (memory) 203, and an auxiliary storage 204 such as a hard disk are connected to a bus 201. Also, a storage medium 206 is connected through an external IF 205, and an inputter 51 or an outputter 52 can be connected through an input/output IF 207. Individual processing blocks of the system can be realized by making the processor 202 loaded on the computer device execute the program. At the time, the system may be realized by installing the program beforehand in the main storage 203 or the auxiliary storage 204 of the computer device, or may be realized by distributing the program through a network and appropriately installing the program in the computer device. Also, the individual storages inside the system may be realized by appropriately utilizing the main storage 203 and the auxiliary storage 204 incorporated in or externally attached to the computer device cr the storage medium 206 such as a CD-R, a CD-RW, a DVD-RAM or a DVD-R or the like.

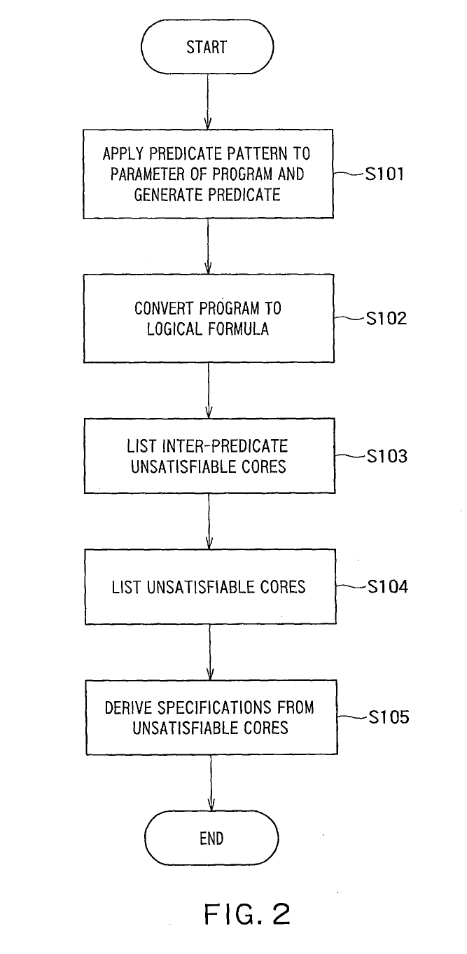

FIG. 2 is a flowchart illustrating the entire processing procedure of the system in FIG. 1.

(Step S101) The program setter 14 receives the text of the program to be the target of the specification estimation from the user. The additional constraint setter 13 receives the additional constraint of the program as the input. As the additional constraint, the negation of the postcondition for instance is received as the input. The predicate generator 22 of the program specification estimation device 21 acquires the program text from the program setter 14. The predicate generator 22 detects the parameter included in the program text and its type, and generates the predicate group including the parameter on the basis of the detected parameter and its type. Also, the plurality of negative covering sets based on the predicate group are generated. The predicate generator 22 stores the generated predicate group in the predicate storage 31, and stores the negative covering sets in the negative covering storage 32.

(Step S102) The program converter 23 in FIG. 1, which corresponds to third circuitry, converts the program text inputted from the program setter 14 to the logical formula. The processing of the program converter 14 may be performed before the predicate generator 22, or may be performed after the processing of the inter-predicate unsatisfiable core lister 24.

(Step S103) The inter-predicate unsatisfiable core lister 24 in FIG. 1 lists the unsatisfiable cores (inter-predicate unsatisfiable cores) which are the minimal sets of the predicates for which respective conjunctions conflict, on the basis of all the predicates inside the predicate storage 31. At the time, the unsatisfiable cores may be acquired by obtaining the correction subsets by utilizing the negative covering sets inside the negative covering storage 32 and converting the correction subsets. The inter-predicate unsatisfiable core lister 24 stores the acquired unsatisfiable cores (inter-predicate unsatisfiable cores) in the inter-predicate unsatisfiable core storage 34. A detailed flow of this step S103 is illustrated in FIG. 5 and FIG. 7 that are already described.

(Step S104) The whole unsatisfiable core lister 25 in FIG. 1, which corresponds to fourth circuitry or a second unsatisfiable core lister, generates the correction subsets on the basis of the inter-predicate unsatisfiable core group stored in the inter-predicate unsatisfiable core storage 34, the program logical formula stored in the program logical formula storage 33, the additional constraint (the negation of the postcondition, here) set by the additional constraint setter 13, and the predicate group stored in the predicate storage 31. Specifically, the solution that makes the logical formula including the disjunction of the individual predicates and the relaxing variables corresponding to the individual predicates, the conjunction of (1) the disjunction of the additional constraint and the relaxing variable corresponding to the additional constraint, (2) the program logical formula and (3) the additional constraint be true is obtained. At the time, the constraint that the number of the relaxing variables to be true is to be equal to or smaller than the number of the negative covering sets, and the constraint that at least one of the predicates included in the inter-predicate unsatisfiable cores becomes true and the rest become false are followed. Then, the set of the predicates for which the relaxing variables are made true is obtained as the correction subset. The whole unsatisfiable core lister 25 converts the acquired correction subsets to the unsatisfiable cores. The whole unsatisfiable core lister 25 stores the acquired unsatisfiable core group in the whole unsatisfiable core storage 35.

The detailed flow of this step S104 is illustrated in FIG. 10 that is already described.

(Step S105 in FIG. 2) The specification deriver 26 generates the specifications (preconditions) on the basis of the unsatisfiable core group stored in the whole unsatisfiable core storage 35. First, the specification deriver 26 specifies only the ones including the additional constraint in the unsatisfiable core group stored in the whole unsatisfiable core storage 35. The specification deriver 26 eliminates the additional constraint from the individual specified unsatisfiable cores. For each set obtained by eliminating the additional constraint, the conjunction of all the elements is taken and one logical formula each is generated as the specification (precondition). The specification deriver 26 delivers the generated specifications to the specification presenter 12. The specification presenter 12 displays the specifications delivered from the specification deriver 26 on the screen of the display device. Thus, the specifications are presented to the user.

As above, according to the present embodiment, without listing the whole unsatisfiable cores in consideration of program execution and the additional constraint all at once, the processing in two stages of obtaining the inter-predicate unsatisfiable cores from the predicate group to be candidate components of the precondition first and utilizing them to obtain the whole unsatisfiable cores is performed. Thus, a search space of the solutions is reduced, and the processing is accelerated. Therefore, all the unsatisfiable cores (the minimal unsatisfiable cores particularly) can be listed at a high speed and in a scalable manner.

Further, by obtaining the inter-predicate unsatisfiable core group in multiple stages by a plurality of processes, further efficiency improvement can be expected. Therefore, the number of the predicates that could not be handled before can be turned to the target. Also, by making multistage processing of obtaining the inter-predicate unsatisfiable core group be parallel, further acceleration can be expected as well.

Also, since the predicate group is prepared so as to form the negative covering set, the inter-predicate correction subsets can be efficiently obtained from the predicate group. Also, from the inter-predicate unsatisfiable core group, the whole correction subsets can be efficiently obtained.

According to the present embodiment, even the preconditions that could not be estimated before due to an excessive calculation amount can be estimated.

(Modification 1)

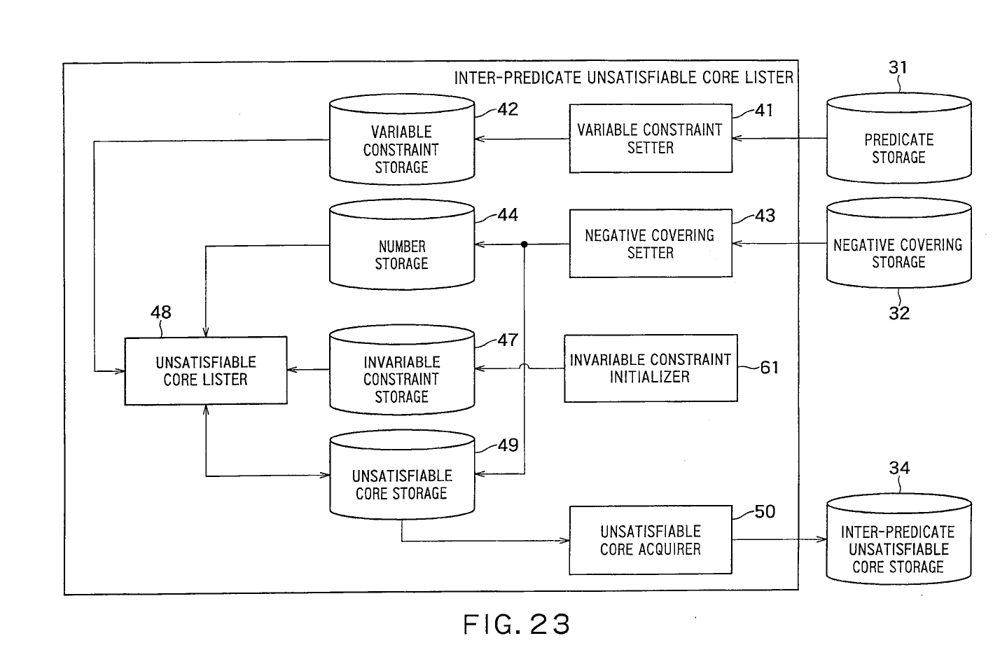

FIG. 23 illustrates an inter-predicate unsatisfiable core lister according to the modification 1. Instead of the inter-predicate unsatisfiable core lister illustrated in FIG. 1 or FIG. 4, the inter-predicate unsatisfiable core lister illustrated in FIG. 23 can be used.

The variable constraint setter 41 stores the predicate group stored in the predicate storage 31 in the variable constraint storage 42. The negative covering setter 43 stores the contents of the negative covering storage 32 in the unsatisfiable core storage 49. Also, the negative covering setter 43 stores the number of the negative covering sets stored in the negative covering storage 32 in the number storage 44. An invariable constraint initializer 61 initializes the contents of the invariable constraint storage 47 to the state that nothing is stored. The unsatisfiable core lister 48 has the configuration similar to the unsatisfiable core lister 48 illustrated in FIG. 8 or FIG. 9, and generates the unsatisfiable cores by performing the processing in the flowchart of FIG. 10. The unsatisfiable core lister 48 stores the generated unsatisfiable cores (inter-predicate unsatisfiable cores) in the unsatisfiable core storage 49. The unsatisfiable core acquirer 50 reads the unsatisfiable cores stored in the unsatisfiable core storage 49 and stores them in the inter-predicate unsatisfiable core storage 34.

In the configuration illustrated in FIG. 23, a part of the configuration of the whole unsatisfiable core lister in FIG. 8 illustrated in advance is shared. However, the program logical formula setter 46 in FIG. 8 is changed to the invariable constraint initializer 61, and an output destination of the unsatisfiable core acquirer 50 in FIG. 8 is changed to the inter-predicate unsatisfiable core storage 34.

Therefore, the whole unsatisfiable core lister illustrated in FIG. 8 can be diverted to perform the processing of the inter-predicate unsatisfiable core lister.

(Modification 2)

In the previous embodiment, in the processing of the correction subset lister 63 inside the partial unsatisfiable core lister A illustrated in FIG. 6 or the correction subset lister 53 inside the unsatisfiable core lister 48 illustrated in FIG. 9, the correction subsets are obtained under the condition that, for the number “N” stored in the number storage A or 44, the number of the relaxing variables to be true is equal to or smaller than “N”.

As a different method, the method of obtaining the same result under the condition that the number of the relaxing variables to be true is strictly “N” (without being equal to or smaller than “N”) is also possible.

In this case, the inter-predicate unsatisfiable core lister 24 additionally stores the correction subsets (inter-predicate correction subsets) stored in the correction subset storage 64 included in the partial unsatisfiable core lister A in the intermediate result storage 53/the inter-predicate unsatisfiable core storage 34. Then, in the processing of the unsatisfiable core converter 55 (see FIG. 9) of the whole unsatisfiable core lister 25, by referring to the inter-predicates correction subsets inside the inter-predicate unsatisfiable core storage 34 and complementing the solutions, the correction subsets are obtained. Specifically it is as follows.

In the previous embodiment, the inter-predicate correction subsets stored in the correction subset storage 64 (see FIG. 6.) are as follows.

{1_{—}1, 2_{—}1, 3_{—}2}, {1_{—}1, 2_{—}2, 3_{—}2}, {1_{—}2, 2_{—}2, 3_{—}1}, {1_{—}2, 2_{—}2, 3_{—}2}, {1_{—}3, 2_{—}2, 3_{—}2}

They do not change whether the condition on the number of the relaxing variables to be true is N≦3 or is strictly N=3.

In the meantime, the correction subsets (whole correction subsets) obtained inside the whole unsatisfiable core lister 25 are as follows.

{1_{—}1, 2_{—}1, 3_{—}2}, {0, 1_{—}1, 2_{—}2, 3_{—}2}, {0, 1_{—}2, 2_{—}2, 3_{—}1}, {0, 1_{—}2, 2_{—}2, 3_{—}2}, {0, 1_{—}3, 2_{—}2, 3_{—}2}

However, when the correction subsets are obtained by turning the number of the relaxing variables to be true not to be N≦4 but to be strictly N=4, only the following are obtained.
{0, 1_{—}1, 2_{—}2, 3_{—}2}, {0, 1_{—}2, 2_{—}2, 3_{—}1}, {0, 1_{—}2, 2_{—}2, 3_{—}2}, {0, 1_{—}3, 2_{—}2, 3_{—}2}

As above, between the inter-predicate correction subsets and the whole correction subsets, there is only a difference of including or not including the index “0” for the latter to the former subsets. Therefore, in the case that the correction subsets are obtained not under the condition that the number of the relaxing variables to be true is equal to or smaller than “N” but under the condition that it strictly matches the “N” pieces, if the solutions are complemented using the inter-predicate correction subsets, the same whole correction subsets as those in the case of using the condition that the number of the relaxing variables to be true is equal to or smaller than “N” can be obtained. That is, even when the index “0” is added in the inter-predicate correction subset group, the correction subsets that do not exist in the whole correction subset group are specified, and the specified correction subsets are added to the whole correction subsets.

In the above-described example, when {1_{—}1, 2_{—}1, 3_{—}2} included in the inter-predicate correction subsets is added to the correction subsets that are {0, 1_{—}1, 2_{—}2, 3_{—}2}, {0, 1_{—}2, 2_{—}2, 3_{—}1}, {0, 1_{—}2, 2_{—}2, 3_{—}2}, and {0, 1_{—}3, 2_{—}2, 3_{—}2} obtained with strict N=4, {1_{—}1, 2_{—}1, 3_{—}2}, {0, 1_{—}1, 2_{—}2, 3_{—}2}, {0, 1_{—}2, 2_{—}2, 3_{—}1}, {0, 1_{—}2, 2_{—}2, 3_{—}2}, and {0, 1_{—}3, 2_{—}2, 3_{—}2} are obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A program specification estimation device, comprising:
first circuitry to analyze a program described by an imperative programming language and detect a parameter included therein, and generate a plurality of negative covering sets each of which includes a plurality of predicates each including the parameter wherein a conjunction of arbitrary zero or more predicates in each negative covering set is a negation of a conjunction of the other predicates therein;
second circuitry to list first unsatisfiable cores that are minimal sets of the predicates that respective conjunctions thereof conflict, on a basis of all the predicates included in the plurality of negative covering sets;
third circuitry to convert the program to a form of a logical formula with use of symbolic execution to obtain a program logical formula; and
fourth circuitry to
(A) set a relaxing variable which takes a true or false value to each of all the predicates included in the plurality of negative covering sets,
(B) obtain a solution that makes a logical formula be true so as to satisfy a first constraint and a second constraint, the logical formula including a conjunction of (1) a disjunction of each of the relaxing variable and the predicate corresponding to each of the relaxing variable, (2) the program logical formula and (3) an additional constraint given beforehand, the first constraint being a constraint related to a number of relaxing variables to be true, that is determined according to a number of the negative covering sets generated by the first circuitry, and the second constraint being a constraint that at least one of the predicates included in each of the first unsatisfiable cores becomes true and the rest of the predicates become false, and
(C) convert a correction subset that is a set of the predicates for which the relaxing variables have become true to a second unsatisfiable core, the second unsatisfiable core being a minimal set of the predicates which cannot be made true simultaneously with the additional constraint in a case of finding a solution that makes a logical formula including a conjunction of (1) the second unsatisfiable core, (2) the program logical formula and (3) the additional constraint be true.

2. The device according to claim 1,
wherein the first constraint is a constraint that the number of the relaxing variables to be true is equal to or smaller than the number of the negative covering sets or a constraint that the number of the relaxing variables to be true coincides with the number.

3. The device according to claim 1,
wherein the fourth circuitry sets the relaxing variable to the additional constraint,
the logical formula further includes a disjunction of the additional constraint and the relaxing variable so as to incorporate the disjunction as a part of the conjunction defined therein,
the fourth circuitry obtains the correction subset which is a set of at least one of the additional constraint and the predicates for which the relaxing variables have become true, and converts the correction subset to a third unsatisfiable core, the third unsatisfiable core being a minimal set of at least one of the additional constraint and the predicates and in which a conjunction of individual elements within the set are unsatisfiable,
the fourth circuitry specifies the third unsatisfiable core including the additional constraint among third unsatisfiable cores, and obtains a set of the predicates included in a specified third unsatisfiable core, the set obtained being the second unsatisfiable core.

4. The device according to claim 3,
wherein the first constraint is a constraint that the number of the relaxing variables to be true is equal to or smaller than a value added by 1 to the number of the negative covering sets or a constraint that the number of the relaxing variables to be true coincides with the value.

5. The device according to claim 1,
wherein the first circuitry reads a plurality of negative covering pattern sets each of which are a set of a plurality of predicate patterns indicating predicate generation rules based on the parameter respectively, and the predicate generated by arbitrary one or more predicate patterns in each negative covering patter conflicts with a conjunction of the predicates generated by the other predicate patterns in each negative covering patter, and
generates the predicates based on the detected parameter according to the predicate patterns for each of the negative covering pattern sets to obtain the plurality of negative covering sets.

6. The device according to claim 5,
wherein the first circuitry detects a type of the parameter from the program, and specifies the negative covering pattern set to be used among the plurality of negative covering pattern sets according to a detected type of the parameter.

7. The device according to claim 5,
wherein the predicate generated by one predicate pattern within the negative covering pattern set is negation of the predicate generated by another predicate pattern within the negative covering pattern set.

8. The device according to claim 1,
wherein the second circuitry generates a first correction subset that is a set of the predicates whose removal from all the predicates included in the plurality of negative covering sets causes a conjunction of the predicates that remain after the removal to be true, on a basis of a constraint related to a size of the first correction subset, that is determined according to a number of the negative covering sets generated by the first circuitry, and
the second circuitry converts the first correction subset to the first unsatisfiable core.

9. The device according to claim 8,
wherein the second circuitry selects “i” (“i” is an arbitrary integer larger than 1 and smaller than a number of the negative covering sets) sets from the plurality of negative covering sets,
generates a correction subset that is a set of the predicates whose removal from all the predicates included in the selected “i” sets causes the conjunction of the predicates that remain after the removal to be true, so as to satisfy a constraint related to a size of the correction subset, that is determined according to a number of the selected negative covering sets,
converts the correction subset to an unsatisfiable core that is a minimal set of the predicates that cannot be simultaneously made true of all the predicates included in the selected “i” sets,
selects “i” sets from among the converted unsatisfiable core and unselected negative covering sets,
generates a correction subset that is a set of the predicates whose removal from all the predicates included in the selected sets causes a conjunction of the predicates that remain after the removal to be true so as to satisfy a constraint related to a size of the correction subset, that is determined according to a number of the negative covering sets selected so far,
converts the correction subset to a unsatisfiable core that is a minimal set of the predicates that cannot be simultaneously made true of all the predicates included in the selected “i” sets, and
the unsatisfiable core finally obtained by repeating similar processing thereafter is the first unsatisfiable core.

10. The device according to claim 9,
wherein the constraint related to the size of the correction subset, that is determined according to the number of the selected negative covering sets is a constraint that the size of the correction subset is equal to or smaller than the number of the selected negative covering sets or a constraint that the size of the correction subset coincides with the number, and
wherein the constraint related to the size of the correction subset, that is determined according to the number of the negative covering sets selected so far is a constraint that the size of the correction subset is equal to or smaller than the number of the negative covering sets selected so far or a constraint that the size of the correction subset coincides with the number.

11. The device according to claim 9,
wherein the second circuitry performs a series of processes including selection of the “i” sets, generation of the correction subset, and conversion to the unsatisfiable core in parallel.

12. A program specification estimation method performed by at least one processor, comprising:
analyzing a program described by an imperative programming language and detect a parameter included therein, and generate a plurality of negative covering sets each of which includes a plurality of predicates each including the parameter wherein a conjunction of arbitrary zero or more predicates in each negative covering set is a negation of a conjunction of the other predicates therein;
listing first unsatisfiable cores that are minimal sets of the predicates that respective conjunctions thereof conflict, on a basis of all the predicates included in the plurality of negative covering sets;
converting the program to a form of a logical formula with use of symbolic execution to obtain a program logical formula; and
setting a relaxing variable which takes a true or false value to each of all the predicates included in the plurality of negative covering sets,
obtaining a solution that makes a logical formula be true so as to satisfy a first constraint and a second constraint, the logical formula including a conjunction of (1) a disjunction of each of the relaxing variable and the predicate corresponding to each of the relaxing variable, (2) the program logical formula and (3) an additional constraint given beforehand, the first constraint being a constraint related to a number of relaxing variables to be true, that is determined according to a number of the negative covering sets, and the second constraint being a constraint that at least one of the predicates included in each of the first unsatisfiable cores becomes true and the rest of the predicates become false, and
converting a correction subset that is a set of the predicates for which the relaxing variables have become true to a second unsatisfiable core, the second unsatisfiable core being a minimal set of the predicates which cannot be made true simultaneously with the additional constraint in a case of finding a solution that makes a logical formula including a conjunction of (1) the second unsatisfiable core, (2) the program logical formula and (3) the additional constraint be true.

13. A non-transitory computer readable medium having instructions stored therein which causes a processor when executed by the processor to execute processing of steps comprising:
analyzing a program described by an imperative programming language and detect a parameter included therein, and generate a plurality of negative covering sets each of which includes a plurality of predicates each including the parameter wherein a conjunction of arbitrary zero or more predicates in each negative covering set is a negation of a conjunction of the other predicates therein;
listing first unsatisfiable cores that are minimal sets of the predicates that respective conjunctions thereof conflict, on a basis of all the predicates included in the plurality of negative covering sets;
converting the program to a form of a logical formula with use of symbolic execution to obtain a program logical formula; and
setting a relaxing variable which takes a true or false value to each of all the predicates included in the plurality of negative covering sets,
obtaining a solution that makes a logical formula be true so as to satisfy a first constraint and a second constraint, the logical formula including a conjunction of (1) a disjunction of each of the relaxing variable and the predicate corresponding to each of the relaxing variable, (2) the program logical formula and (3) an additional constraint given beforehand, the first constraint being a constraint related to a number of relaxing variables to be true, that is determined according to a number of the negative covering sets, and the second constraint being a constraint that at least one of the predicates included in each of the first unsatisfiable cores becomes true and the rest of the predicates become false, and
converting a correction subset that is a set of the predicates for which the relaxing variables have become true to a second unsatisfiable core, the second unsatisfiable core being a minimal set of the predicates which cannot be made true simultaneously with the additional constraint in a case of finding a solution that makes a logical formula including a conjunction of (1) the second unsatisfiable core, (2) the program logical formula and (3) the additional constraint be true.
